(19) United States
(12) Patent Application Publication
(10) Pub. No.: US 2012/0319588 A1
(43) Pub. Date: Dec. 20, 2012

(54) SYSTEMS AND METHOD FOR ADAPTIVE MONITORING AND OPERATING OF ELECTRONIC BALLASTS

(75) Inventor: Alberto Sid, Upper Saddle River, NJ (US)

(73) Assignee: MAF TECHNOLOGIES CORPORATION, Upper Saddle River, NJ (US)

(21) Appl. No.: 13/163,886

(22) Filed: Jun. 20, 2011

(51) Int. Cl. H05B 37/02; H01J 7/42

(52) U.S. Cl. 315/129; 315/291

(57) ABSTRACT

An assembly, system and method for adaptively monitoring and operating a lamp fixture include a power input interface, a ballast, and a lamp interface. The ballast is coupled to the power input interface for receiving the received input power and creating lamp power between a first lamp terminal and a second lamp terminal. The ballast includes a transformer having a primary winding, a first lamp powering secondary winding, and a second lamp powering secondary winding. The transformer further includes a non-lamp powering secondary or third secondary winding for detecting a ballast operating parameter and transmitting a sensed ballast operating parameter value corresponding to the detected ballast operating parameter. A sensor detects an arc current circulating through a lamp received in the lamp interface and transmits a sensed arc current value corresponding to the detected arc current. One or more output interfaces provide the transmitted sensed arc current value and transmitted sensed ballast operating parameter value to an external system communicatively coupled.

### FIELD

The present disclosure relates to electronic control devices for lamps and, more specifically, to systems and method for adaptively monitoring and operating electronic ballast for gas discharge lamps.

### BACKGROUND

The statements in this section merely provide background information related to the present disclosure and does not constitute prior art.

Gas-discharge lamps include fluorescent lamps or fluorescent tubes that use electricity to excite mercury vapor. The excited mercury atoms produce short-wave ultraviolet light that causes a phosphor to fluoresce, producing visible light. The excited mercury atoms producing short-wave ultraviolet light can be also controlled to emit UV-A, UV-B and UV-C ultraviolet light used in many applications such as for germicidal purposes. A fluorescent lamp converts electrical power into useful light more efficiently than an incandescent lamp. FIG. 1 illustrates the components of a common gas discharge lamp. A lamp has two cathodes, 110, identified in as cathodes 110A and 110B, that receive lamp power for powering lamp 100 and provides power to filament 112. The lamp 100 includes glass tube 130 that captures a gas 140 therein. A small amount of mercury 120 is included. When lamp 100 is operational, electrical current flows from cathode 110A to cathode 110B or vice-versa.

However, lower energy costs are typically offset by the higher initial cost of the lamp. A lamp fixture for a gas discharge lamp is more costly because it requires a ballast to regulate the current through the lamp. Fluorescent lamps are negative differential resistance devices, so as more current flows through them, the electrical resistance of the fluorescent lamp drops, allowing even more current to flow. Connected directly to a constant-voltage power supply, a fluorescent lamp would rapidly self-destruct due to the uncontrolled current flow. To prevent this, fluorescent lamps must use an auxiliary device, a ballast, to regulate the current flow through the gas discharge lamp tube.

The terminal voltage across an operating lamp varies depending on the arc current, the diameter of the lamp tube, the operating temperature, and type of gas used to fill the gas discharge tube. A fixed part of the voltage drop is associated with the lamp electrodes. A general lighting service T12 48 inch (1200 mm) lamp operates at 430 mA, which has a 100 volt drop across the lamp electrodes. High output lamps operate at 800 mA, and some types operate up to 1500 mA. The power level varies from 10 watts per foot (33 watts per meter) to 25 watts per foot (82 watts per meter) of tube length for T12 lamps.

The simplest ballast for alternating current (AC) lamps is an inductor placed in series with the lamp terminal. The inductor consists of a winding on a laminated magnetic core. The inductance of the inductor winding limits the flow of AC current. This type of ballast is used, for example, in 120 volt operated desk lamps using relatively short lamps. Ballasts are rated for the size of lamp and power frequency. Often, the input or mains voltage is insufficient to start a long fluorescent lamp. In such cases, the ballast often includes a step-up transformer that has a substantial amount of leakage inductance that limits the current flow. Additionally, in any type inductive ballast a capacitor can be included in the circuit to provide a power factor correction.

FIG. 2 represents a typical schematized block diagram of an electronic fluorescent ballast 200 showing AC power supply 202 providing power to EMI filter (electromagnetic interference filter) 210 which provides for eliminating or controlling noise radiated and conducted back to the AC power supply 202. A rectifier 220 rectifies power from AC (alternating current) to DC (direct current). A DC filter 230 cleans up ripple after rectification of AC output from rectifier 220. A DC-AC inverter 240 and ballast stages makes up the power stage of the electronic ballast and provides for the generation of the lamp powering voltage and current as provided to the lamp 100 via cathodes 110, via lamp interface 252. Additionally, in some embodiments, a feedback loop 226 is provided back to the DC-AC inverter 240. Furthermore, in some embodiments a dimming control module 224 can provide a function of dimming or adjusting the intensity of the lamp 100 connected to the ballast 250. Dimming control module is often implemented by various known methods of dimming the power delivered to the lamps 100. For example, one of the more prevalent methods is the use of a change in the analog voltage. A second one method for dimming the power is to use phase width modulation (PCM) as the input power to the ballast 250. In this later arrangement, the duty cycle of the square wave driving the ballast 250 is changed, literally switching the ballast 250 on/off. For example, if the duty cycle is 50% the ballast 250 is turned on for half the time and off the other half.

FIG. 3 is a circuit diagram of typical commercial push pull ballast 300. This ballast topology is widely used in the industry due to its simplicity and low manufacturing cost suitable for mass production. The operation of this type of topology is well known to the experts on the trade, and it escapes the scope of the disclosure, so therefore will only be briefly discussed. As shown input power 242 is provided to the ballast 300 to power drive circuits 302A and 302B. Each drive circuit 302A and 302B is coupled to a core 304 as primary winding P1 and P2, respectively. A first secondary winding Si is coupled to the core and provides lamp power via cathode lead 310 to lamp cathode 110A. A second secondary winding S2 is coupled to the core and provides lamp power via cathode lead 320 to lamp cathode 110B. The lamp interface 252 is defined between the two lamp cathodes 110A and 110B. This ballast circuit 300 is one exemplary embodiment of a simple design, but such design and its simplicity should not be considered limiting to the scope of the present disclosure.

In such Push-pull resonant circuits 300, a considered advantage is that the circuit can tolerate open or short circuited loads indefinitely. As such, circuit 300 is often used in large ballasts 250. It generates a nearly perfect sinusoidal voltage through the lamp 100 with each transistor producing half of the sin wave. The circuit 300 oscillates due to the capacitor C, and the inductance of the transformer T1. The inductor L acts as a constant current source, maintaining the resonant circuit in oscillation by feeding energy into it to compensate for that absorbed by the load, e.g., the lamp 100. The oscillation is triggered by drive circuits 302A and 302B, which pulls up the base-emitter voltage of the transistors. Once the oscillation has started, and before the lamp 100 is ionized, the windings S1 and S2 generate a current to heat the lamp filaments, the output winding S3 of ballast 250 generate the high voltage required to ionize the lamp by initially generating a voltage that effectively connected across an open load.

Once the lamp 100 is ionized, supplementary winding S2 provides the lamp power or drive for the lamp 100. As the impedance of the lamp 100 has fallen, the voltage across the supplementary winding S2 is much smaller in this situation than in start-up. The voltage across the S1 and S3, and consequently the filament currents, is also reduced.

Base drive power for the transistors T1 is provided by means of feedback windings from the output transformer. The collector-current spikes at each switching event are caused by both transistors conducting simultaneously: one in the forward direction, and the other in the reverse, through a collector-base diode.

Gas discharge lamps, such as fluorescent lamps (generally referred herein as gas discharge lamps), can be powered directly from a direct current (DC) power supply that has sufficient voltage to strike an arc. In such cases, the ballast must be resistive, and would consume about as much power as the lamp. When operated from DC, the starting switch is often arranged to reverse the polarity of the supply to the lamp each time it is started since operating a single polarity gas discharge lamp can result in the mercury accumulating at one end of the tube. However, fluorescent lamps are almost never operated directly from DC power. Rather, even where DC power is the primary power source, such as on a motor vehicle, an inverter is used to convert the DC power supply into AC power for powering of the gas discharge lamp. Such an inverter also provides the current-limiting function of the electronic ballast.

The light output and performance of fluorescent lamps is critically affected by the temperature of the wall of the bulb of the lamp as the temperature of the bulb wall affects the partial pressure of mercury vapor within the lamp. Each lamp contains a small amount of mercury, which must vaporize to support the lamp current and generate light. At low temperatures, the mercury is in the form of dispersed liquid droplets. As the lamp warms, more of the mercury is in vapor form. At higher temperatures, self-absorption in the vapor reduces the yield of UV and visible light.

Modern electronic ballasts employ transistors to increase the frequency of the primary input voltage, referred to as the mains voltage, into a higher frequency AC while also regulating the current flow in the lamp. These electronic ballasts take advantage of the fact that gas discharge lamps are more efficient when operated at higher-frequency current. Efficiency of a fluorescent lamp rises by almost 10% at a frequency of 10 kHz as compared to the efficiency of a lamp operating at 60, 100 or 120 Hz. Since introduction in the 1990s, high frequency ballasts have been used in general lighting fixtures with either rapid start or pre-heat lamps. These ballasts convert the incoming power to an output frequency in excess of 20 kHz. This increase in frequency has further increased lamp efficiency. When the AC period is shorter than the relaxation time to de-ionize mercury atoms in the discharge column, the discharge stays closer to optimum operating condition. Electronic ballasts typically work in rapid start or instant start mode. Electronic ballasts are commonly supplied with AC power. The input AC power is converted by the ballast into DC power and then inverted back into a desired lamp powering AC waveform that often have a constant current pulse width and frequency. Depending upon the capacitance and the quality of constant-current pulse-width modulation, the modulation of the lamp powering at 100 or 120 Hz can be largely eliminated.

Modern low cost ballasts utilize a simple oscillator and series resonant LC circuit. When turned on, the oscillator starts, and the LC circuit charges. After a short time, the voltage across the lamp reaches about 1 kV and the lamp ignites. This process is however often too fast to preheat the cathodes. As such, the lamp with the cold cathodes instant-starts in what is referred to as cold cathode mode. In this mode, the cathode filaments are used for protection of the ballast from overheating if the lamp does not ignite. A few manufacturers use positive temperature coefficient (PTC) thermistors to disable instant starting. By providing power to the cathodes without allowing the lamp to start, the cathode and filaments can be preheated so that the lamp can start once the power is applied.

More complex electronic ballasts use programmed starting methods. In these cases, the output AC frequency is started at a higher frequency than the resonance frequency of the output circuit of the ballast. This higher frequency current acts to preheat the filaments or cathodes. After the cathodes are preheated for a predetermined amount of time, the ballast rapidly decreases the frequency of the current. If the frequency approaches the resonant frequency of the ballast, the output voltage will increase so that the lamp ignites. If the lamp does not ignite, an electronic circuit stops the operation of the ballast.

Many electronic ballasts are controlled by a microcontroller or processor. These are sometimes called digital ballasts. Digital ballasts apply software logic to aid in lamp providing power to the lamp for starting and operation. Digital ballasts can be programmed to enable functions such as testing for broken electrodes and missing tubes before providing power for lamp starting, auto detection for tube replacement, and auto detection of tube type. In this later case, a single ballast design can be used with several different types of tube fixtures each with a different type of lamp tubes or those designed to operate at different arc currents or frequencies. Once such fine grained control over the starting and arc current is achievable, features such as dimming, and having the ballast maintain a constant light level against changing operating sunlight can be included in the digital ballast software.

Many electronic ballast used in conjunction with fluorescent lamps or other types of gas discharge lamps such as visible spectrum lights for general illumination; UV-A, UV-B, UV-C emitting lamps; germicidal lamps; and tanning lamps, by ways of example, have been provided with status or warning lights to notify persons of specific lamp operating conditions, some of which can be attributed with a predetermined maintenance issue or situation. For example, electronic ballasts have included status lights that indicate that a lamp or a plurality of lamps needs to be replaced. In other cases, electronic ballasts have included status light that indicate that the ballast is oscillating at its proper resonating frequency, or that indicate that the ballast operating power supplied voltage is within acceptable range, i.e., the input voltage is not too high or too low so that it can compromises the operation of the lamp fixture. Other electronic ballasts have included status displays that indicate the remaining life of the lamp or plurality of lamps before replacement is required. Still other electronic ballasts have status displays that provide a message indication that the lamp or plurality of lamps is operating at their proper operating electrical characteristics, such as voltage and current.

FIG. 4 illustrates a circuit diagram of a commercial lamp fixture assembly 400 for monitoring a gas discharge lamp. The ballast 250 shows only one cathode 110 for simplicity purposes. The leads from ballast 250 to cathodes 110 are passed thru current transducer 402. The current transducer 402 can be any suitable transducer such as a Zettler Magnetics' toroid as shown by way of example in FIG. 5. As shown in FIGS. 5A, 5B, 5C and 5D are various images of an exemplary current transducer 402. FIG. 5A is a front view of the physical implementation of the exemplary transducer 402 wherein FIG. 5B is a side view and FIG. 5C is a bottom view. FIG. 5D is an electrical representation of the current transducer 402 as shown; this illustrated embodiment is essentially a transformer having a toroidal ferrite core 420, two primary windings L1 and L2 and a secondary winding L3. FIG. 5D illustrates one assignment of pins for attachment or coupling of the current transducer 402 in an implementation. It should be understood to those skilled in the art that other implementation and embodiments are also available.

When both leads to the cathodes 110 pass through the current transducer 402 the currents from the opposing primary windings of the ballast transformer cancel out the cathode currents leaving only the arc current at the output 404 of the current transducer 402, e.g., the measured parameter is the arc current at output 404. Output 404 of transducer 402 is then used to power optocoupler 406 depending on the current circulating on the lamp 100. Optocoupler 406 (such as the type of PS2501) includes a light emitting diode (LED) 408 on the input side and a light receiving phototransistor 410 on the output side. Resistor R1 limits the current to LED 408. A major disadvantage of this detection circuit 400 is the inherent non-linearity of the diode's side of optocoupler 406. Because the output of the phototransistor 410 of the optocoupler 406 is also a non-linear device (a transistor), the optocoupler 406 generally fails to produce an accurate representation or measurement of the arc operating current of the lamp 100. Moreover, the method of detection of circuit 400 is highly sensitive to the input power 242 to the ballast 250 and as such this solution can render its representation of the state of the lamp 100 essentially useless as it inherently provides false indications of the operating status. Phototransistor 410 of optocoupler 406 acts as an analog to digital translator. In the absence of voltage provided by current transducer 402 (such as the case of a burnt lamp 100) LED 408 does not result in output from phototransistor 410. Normally the output terminal of phototransistor 410 will be pulled high via an external resistor to accomplish digital level signals. When this occurs (such as with a burnt lamp 100) the output will be pulled high when referenced to the common terminal. When the voltage provided by current transducer 402 reaches a certain threshold (such as the case of a good lamp 100) light emitted by LED 408 saturates phototransistor 410, setting the output terminal near saturation voltage of the phototransistor (which is the equivalent of a logical “0”) indicating the lamp 100 is good.

In this circuit a second optocoupler 412 with LED 414 on the input side and phototransistor 416 on the output side is positioned between the two output leads of the ballast 250 that provide lamp voltage to the cathode 110. The second optocoupler 412 is provided to detect the oscillating voltage as output by the ballast 250. For same non-linearity reasons as discussed above with regard to optocoupler 406, this also works on a very limited range input voltage range. Additionally, the output 418 of both optical isolators 406 and 412 are non-rectified outputs, switching at the ballast frequency of operation, requiring yet more additional hardware to translate those messages into truly digital indicator messages. LED 414 of coupler 412 is operated by sampled voltage from lamp cathode's 110. When the ballast 250 is not oscillating, voltage present at lamp cathode's 110 will be near zero volts.

FIG. 6 is a circuit diagram of more elaborated commercial ballast circuit 600 showing another implementation of a toroid current transducer 402 for arc current sensing. In ballast 600, input AC power 202 of 230 VAC is provided through EMI filter 210 to rectifier 220. The DC filter 230 receives the output of rectifier 220 and provides power to ballast 250 that in turn provides lamp power to leads that connect to cathodes 110A and 110B connected to lamp 100. The current transducer 402 is coupled to the cathode leads. The DC-AC inverter 240 is coupled to the transistors of the ballast 250 and also to the current transducer 402. However, the ballast circuit 600 has limitations in that it does not provide for a ballast designed to supply rated lamp power at nominal supply AC voltages will have reduced light output at lower than nominal supply voltages and reduced lamp life at higher than nominal supply voltages. FIG. 6 shows the use of current transducer 402 that is configured and used in a feedback loop configuration to maintain constant lamp current over the entire AC supply voltage, thus maintaining constant light throughout the entire range of input supply voltages. The secondary winding of current transducer 402 produces a voltage across a (fixed value) resistor proportional to lamp current and this voltage is used as the offset bias to control oscillator frequency in order to maintain constant power output to the lamp.

### SUMMARY

The inventor has identified these problems and limitations and has identified a need for a gas discharge ballast and lamp fixture that provides capabilities not previously provided. The inventor hereof has succeeded at designing ballast with a built in transformer sensing capability and a system and method of adaptively monitoring, reporting and operating a gas discharge lamp fixture that is improved over the prior art. The present systems provide for a gas discharge lamp fixture that has a monitoring capability that is self-contained in the electronic ballast that can communicate to external systems or appliances the status, operating parameter values, and health of one or both of the ballast and the one or more powered lamps.

According to one aspect, an assembly for adaptively monitoring operation of a lamp fixture includes a power input interface, a ballast, and a lamp interface. The power input interface receives input power from an external power source. The ballast is coupled to the power input interface for receiving the received input power and creating lamp power between a first lamp terminal and a second lamp terminal. The created lamp power includes a terminal voltage and a variable lamp current. The ballast includes a transformer having a primary winding for receiving at least a portion of the input power. The transformer also includes a first lamp powering secondary winding coupled to the first lamp terminal and a second lamp powering secondary winding coupled to the second lamp terminal. The transformer further includes a non-lamp powering secondary winding for detecting a ballast operating parameter and transmitting a sensed ballast operating parameter value corresponding to the detected ballast operating parameter. The lamp interface is defined between the first lamp terminal and the second lamp terminal for receiving a lamp for providing light or energy responsive to receiving lamp power from the first and second lamp terminals. The sensor detects an arc current circulating through a lamp received in the lamp interface and transmits a sensed arc current value corresponding to the detected arc current. A first output interface is coupled to the sensor and provides the transmitted sensed arc current value to an external system communicatively coupled to the first output interface. A second output interface is coupled to the third secondary winding and provides the transmitted sensed ballast operating parameter value to an external system communicatively coupled to the second output interface.

According to another aspect, an assembly for adaptively monitoring and operating a lamp fixture, the assembly comprising a power input interface for receiving input power from an external power source, a ballast coupled to the power input interface receiving the received input power and creating lamp power between a first lamp terminal and a second lamp terminal, the created lamp power including a terminal voltage and a variable lamp current, a lamp interface defined between the first lamp terminal and the second lamp terminal for receiving a gas discharge lamp for providing light responsive to receiving lamp power from the first and second lamp terminals, a first sensor for detecting an arc current circulating through a lamp received in the lamp interface, the first sensor transmitting a sensed arc current value corresponding to the detected arc current, a second sensor associated with the ballast for detecting an operating parameter of the ballast, the second sensor transmitting a sensed ballast operating parameter value corresponding to the ballast operating parameter, a memory for storing a threshold arc current value, a threshold ballast operating parameter value, and computer executable instructions, and a processor coupled to the memory, the first sensor and the second sensor, the processor receiving the transmitted sensed arc current value from the first sensor, and the sensed ballast operating parameter value from the second sensor, the processor receiving from the memory and executing the computer executable instructions for performing the method of receiving and storing the sensed arc current value and the sensed ballast operating parameter value, comparing the sensed arc current value with the stored threshold arc current value, generating a lamp status message responsive to the comparing of the sensed current value, comparing the sensed ballast operating parameter value with the stored threshold ballast operating parameter value, and generating a ballast status message responsive to the comparing of the sensed ballast operating parameter value.

According to yet another aspect, an assembly for adaptively monitoring operation of a lamp fixture includes a power input interface, a ballast, a lamp interface, a sensor a clock and a processor. The power input interface receives input power from an external power source and provides lamp power to the ballast, among other components of the system. The ballast is coupled to the power input interface to receive the received input power and create lamp power between a first lamp terminal and a second lamp terminal. The created lamp power includes a terminal voltage and a variable lamp current. The lamp interface is defined between the first lamp terminal and the second lamp terminal for receiving a gas discharge lamp for providing light and or energy responsive to receiving lamp power from the first and second lamp terminals. The sensor detects an arc current circulating through a lamp that is received in the lamp interface and transmits a sensed arc current value that is the detected arc current. The clock provides for determining a current time and a memory provides for storing a threshold arc current value, and computer executable instructions. The processor is coupled to the memory, the clock, and the first sensor for receiving the determined current time from the clock, the transmitted sensed arc current value from the first sensor, and the computer executable instructions. The process executes the instructions for performing the method of detecting the receiving of a new lamp into the lamp interface, determining from the clock a new lamp time corresponding to the detecting of the new lamp, and receiving and storing in the memory a new lamp sensed arc current value. The method also includes determining an age of the lamp as a function of a difference between a current time and the stored new lamp time, comparing the current sensed arc current value and the current sensed arc voltage value with the stored new lamp sensed arc current value, and determining an end of life of the lamp as a function of the comparing to the stored new lamp arc current value. The method can also include generating an end of lamp life message indicative of the determined end of life of the lamp.

According to still another aspect, a ballast for use with a lamp fixture includes a power input interface for receiving input power from an external power source, a transformer, and output interface. The transformer has primary winding for receiving at least a portion of the input power, a first secondary winding coupled to a first lamp terminal, and a second secondary winding coupled to a second lamp terminal. The transformer creates lamp power between the first lamp terminal and the second lamp terminal that includes a terminal voltage and a variable lamp current. A lamp interface is defined between the first lamp terminal and the second lamp terminal for receiving a lamp for providing light or energy responsive to receiving the lamp power from the first and second lamp terminals. A third secondary winding detects an induced voltage and transmits a sensed ballast operating voltage value corresponding to the detected induced ballast voltage. The third secondary winding is magnetically coupled to the primary winding, and the first and second secondary windings, but is electrically isolated from each and from the lamp interface. The output interface is coupled to the third secondary winding for providing the transmitted sensed ballast operating voltage to an external system communicatively coupled to the output interface.

Further aspects of the present disclosure will be in part apparent and in part pointed out below. It should be understood that various aspects of the disclosure can be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a diagram of a typical commercial gas discharge fluorescent or UV light lamp.

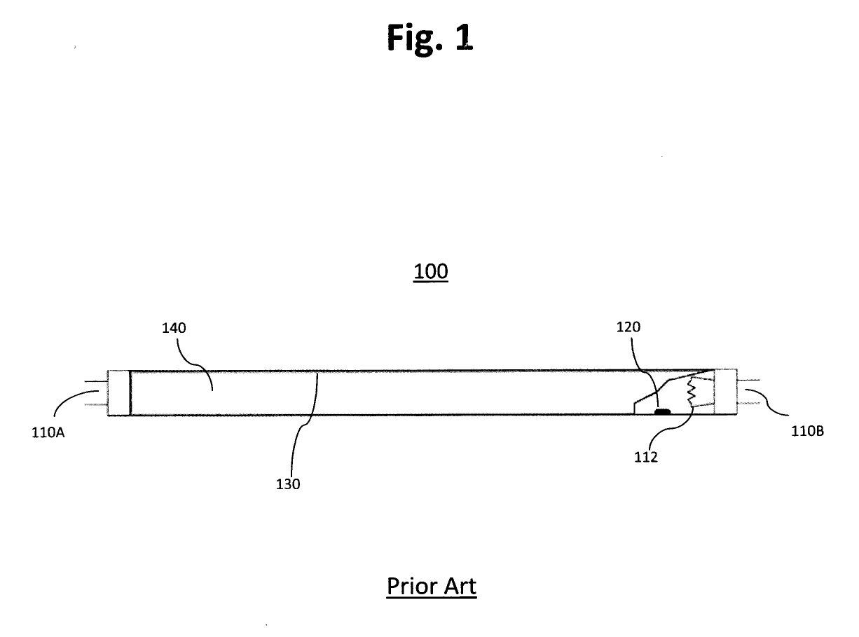

FIG. 2 is a schematized block diagram of typical commercial electronic ballast for a gas discharge lamp.

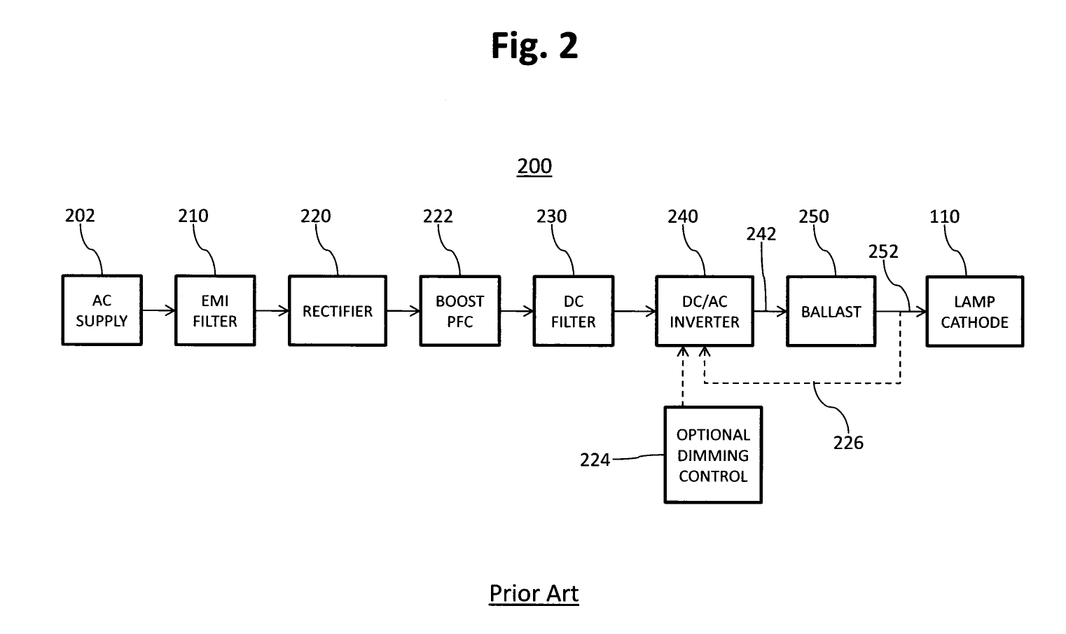

FIG. 3 is a circuit diagram of one typical commercial pull electronic ballast for a gas discharge lamp.

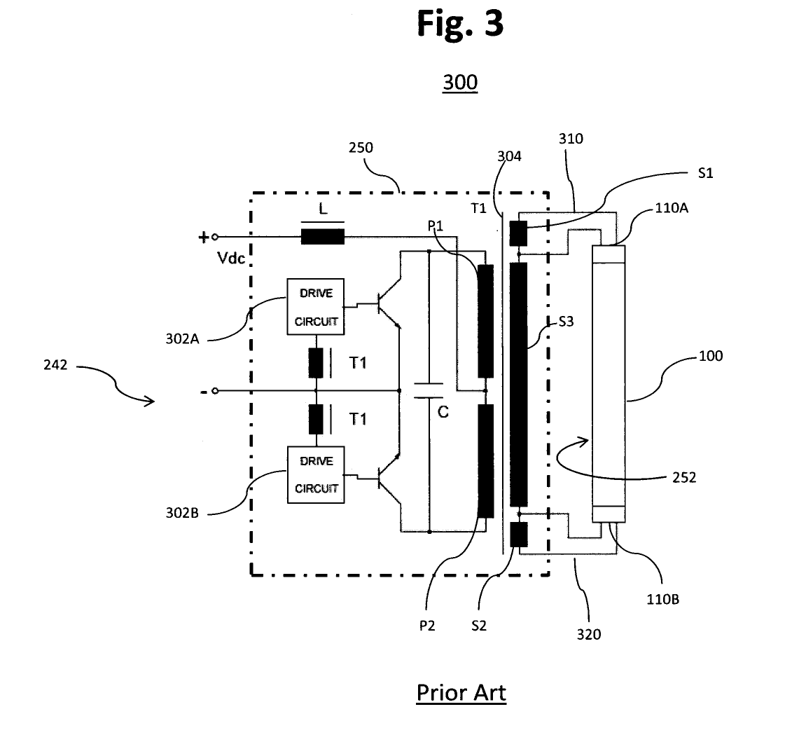

FIG. 4 is a circuit diagram of a primitive commercial implementation of a system to detect lamp and ballast operation implemented in older commercial ballasts.

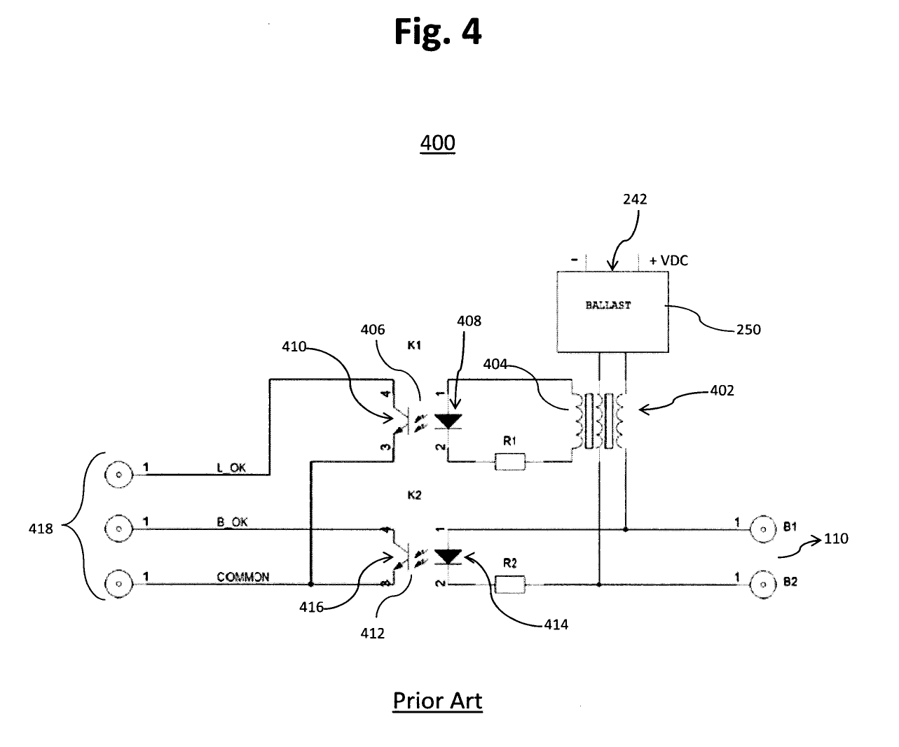

FIG. 5 includes FIGS. 5A through 5D that are illustrations of one exemplary commercial are current sensor in the form of a toroid transformer that is suitable for use with the systems and methods of the present disclosure.

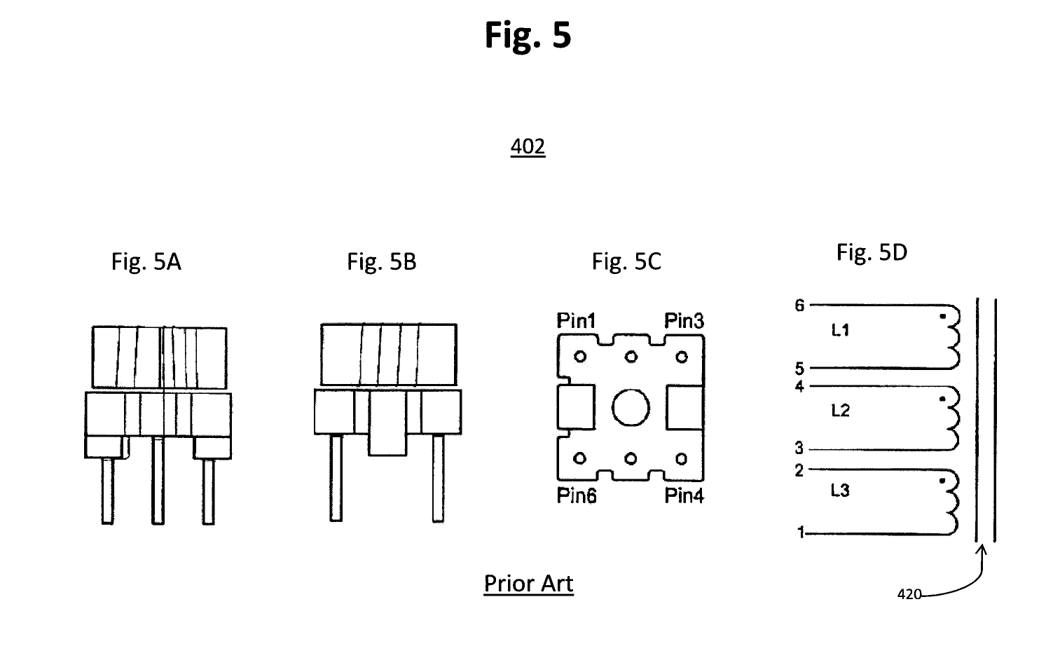

FIG. 6 is a circuit diagram of commercial ballast showing an example of a toroid current transducer for arc current sensing.

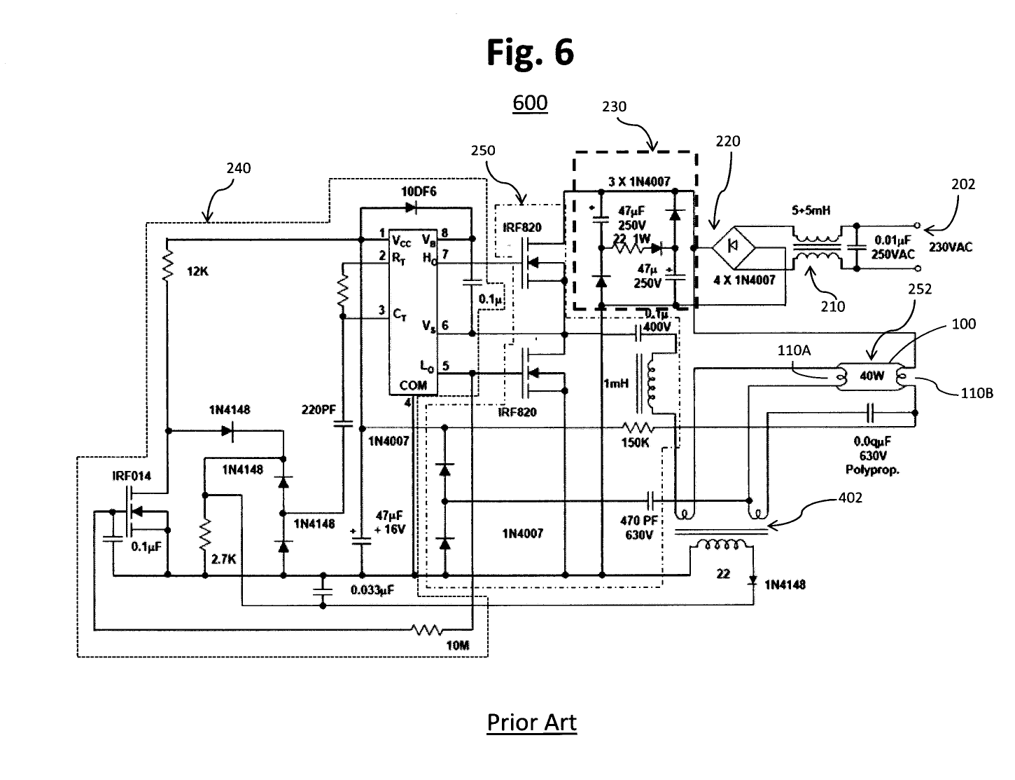

FIG. 7 is schematic block diagram of a system for adaptive monitoring and controlling of an electronic ballast for a gas discharge lamp according to one exemplary embodiment.

FIG. 8 is schematic block diagram of a system for adaptive monitoring and controlling of an electronic ballast for a gas discharge lamp according to another exemplary embodiment.

FIG. 9 is an illustration of a single byte message format including a bit-level allocation to different electronic ballast system status codes according to one exemplary embodiment.

FIG. 10 is an illustration of a two byte message format including exemplary assignment of the bits for communicating and describing the operations of a system for adaptive monitoring and controlling of an electronic ballast according to one exemplary embodiment.

FIG. 11 is a logic state chart using two digital lines illustrating exemplary status codes of a system for adaptive monitoring and controlling of an electronic ballast according to one exemplary embodiment.

FIG. 12 is a process flow chart illustrating a method for adaptive monitoring and controlling of an electronic ballast for a gas discharge lamp using two digital lines to communicate with an external system detected error events as identified in the exemplary logic state chart of FIG. 11, according to one exemplary embodiment.

FIG. 13 is a process flow chart of a method for adaptive monitoring and controlling of an electronic ballast for a gas discharge lamp where the method receives threshold parameters via serial communication lines according to one exemplary embodiment.

FIG. 14 is a process flow chart of a method for adaptive monitoring and controlling of an electronic ballast for a gas discharge lamp for detecting an age of a lamp and reporting an aged lamp that needs replacement.

FIG. 15 is a block diagram of a computer system or CPU that can be used to implement various portions of the herein described methods and computer implemented components of the present disclosure.

It should be understood that throughout the drawings, corresponding reference numerals indicate like or corresponding parts and features.

### DETAILED DESCRIPTION

The following description is merely exemplary in nature and is not intended to limit the present disclosure or the disclosure's applications or uses.

Before turning to the figures and the various exemplary embodiments illustrated therein, a detailed overview of various embodiments and aspects is provided for purposes of breadth of scope, context, clarity, and completeness.

In one embodiment, a ballast for use with a lamp fixture for adaptively monitoring and operating a gas discharge lamp includes a lamp power input interface, a transformer, and an output interface. The lamp power input interface is configured to receive input power from an external power source. This power source to the ballast is typically an AC power source. The transformer has a primary winding coupled to a core of the transformer for receiving all or a portion of the input lamp power as received from the lamp power input interface. The transformer also has a first and a second secondary winding magnetically coupled to the transformer core. The first secondary winding is electrically coupled to a first lamp terminal and the second secondary winding is electrically coupled to a second lamp terminal. The first and second secondary windings provide or create lamp power between the first lamp terminal and the second lamp terminal for powering a gas discharge lamp that is placed therebetween. The created lamp power has a terminal voltage and a variable lamp current that is provided at a lamp interface that is defined between the first lamp terminal and the second lamp terminal. The lamp interface is configured for receiving a lamp for activation responsive to receiving the lamp power from the first and second lamp terminals.

The transformer also includes a third secondary winding that is not coupled to either the first or second secondary windings or the first or second lamp terminals. The third secondary winding is magnetically coupled to the both the primary winding and the first and second secondary windings via the transformer core. The third secondary winding can also be referred to as a non-lamp powering secondary winding. The third secondary winding, while not electrically coupled to the lamp, provides for detecting an operating parameter of the ballast (ballast operating parameter) and transmitting a sensed ballast operating parameter value corresponding to the detected ballast operating parameter to another systems. The ballast operating parameter can be any suitable detectable parameter and in some embodiments can be an induced voltage or frequency. This third secondary winding acts as a sensor for providing or transmitting a sensed ballast operating parameter value or values from its windings that correspond to the detected induced ballast voltage. The third secondary winding is magnetically coupled to the primary winding and therefore can detect the operating condition of the primary winding. Additionally, the third secondary winding is magnetically coupled to the first and second secondary windings via the core and through their magnetic coupling with the primary winding. As such, the third secondary winding can detect operating characteristics of the first and second secondary windings that are electrically coupled to the lamp interface without itself being electrically coupled to the lamp interface. In other words, the third secondary winding provides an electrically isolated sensing of the lamp interface via the ballast transformer. The ballast includes an output interface that is coupled to the third secondary winding for providing the transmitted sensed ballast operating voltage to an external system communicatively coupled to the output interface. This output interface can be an analog or digital interface that is coupled to any type of remote or local system that is external to the ballast itself, such as another component of the lamp fixture.

Further in some embodiments, the ballast can also include a sensor for detecting an arc current circulating through a lamp received in the lamp interface. This arc current sensor can be any type of suitable sensor for detecting current through a lamp positioned in the lamp interface. For example, this sensor can be a current transducer coupled to at least one of the first lamp terminal and the second lamp terminal.

This arc current sensor transmits a sensed arc current value corresponding to the detected arc current. The transmitted sensed arc current value can be provided over a second output interface of the ballast that is also an analog or digital interface. The second output interface is second as compared to the first output interface as described above that is coupled to the third secondary winding. The second output interface is coupled to the sensor for providing the transmitted sensed arc current value to an external system communicatively coupled to the second output interface.

In another embodiment, an assembly for adaptively monitoring operation of a lamp fixture includes a power input interface, a ballast, a lamp interface, a sensor, and first and second output interfaces. The power input interface is for receiving input power from an external power source and for providing the input lamp power to the ballast. The power input interface can also provide other functions for the assembly in addition to providing lamp power to the ballast. The ballast is as described above, and can include or exclude the third secondary winding, as another form of a ballast sensor is also possible in some embodiments.

In another embodiment, an assembly for adaptively monitoring and operating of a lamp fixture includes a power input interface, a ballast, a lamp interface, a first and second sensor, a memory, a processor and computer executable instructions for performing method steps for adaptively monitoring and operating the lamp fixture.

The power input interface, a ballast, a lamp interface can be as described above. The assembly also includes a first sensor that detects an arc current circulating through the lamp and the ballast operating parameter sensor such as the third secondary winding as described by way of example above can act as a second sensor for detecting a ballast operating parameter value. A memory stores a threshold arc current value, a threshold ballast operating parameter value, and computer executable instructions. The values and instructions stored in the memory can be obtained from an external source such as via an input interface to the assembly, or the thresholds can be provided by the processor through processing of the instructions, if so programed. The input interface, where provided, can be coupled to the processor or the memory for receiving the threshold arc current value and the threshold ballast operating parameter value from an external source, such as through a data interface or message.

A processor is coupled to the memory, the first sensor and the second sensor. The processor receives the transmitted sensed arc current value from the first sensor, and the sensed ballast operating parameter value from the second sensor. The processor also receives from the memory the corresponding threshold values and executes the computer executable instructions for performing the method of operating of the assembly for adaptively monitoring and operating the lamp fixture. In one embodiment, the computer executable instructions include instructions for performing the method of receiving and storing the sensed arc current value and the sensed ballast operating parameter value. These values are compared to the corresponding threshold values as retrieved from the memory. The method than provides for one or more messages based on the result of the comparing. This can includes generating a lamp status message responsive to the comparing of the sensed current value and generating a ballast status message responsive to the comparing of the sensed ballast operating parameter value. These messages can be a variety of messages and message formats, some of which will be described by way of example below.

The third secondary winding or another form of a ballast voltage sensor can provide for detecting an operating voltage of the ballast. The processor is coupled to the ballast voltage sensor for receiving a detected ballast operating voltage, and has computer executable instructions for comparing detected ballast operating voltage to the stored ballast voltage threshold value. The processor generates a ballast operating voltage status message indicative of the comparing of the detected ballast operating voltage.

In another exemplary embodiment, as discussed above, one of the ballast operating parameters can be a frequency of the ballast. In such cases, the third secondary winding or a separate frequency sensor can provide for detecting the operating frequency of the ballast and providing such value to the processor. The memory would store a ballast frequency threshold value, such as a high and low value. The processor could use computer executable instructions for comparing the detected ballast operating frequency to the stored ballast frequency threshold value or values and then generate a ballast frequency status message that is indicative of the comparison.

In yet another embodiment, a ballast current sensor can be provided for detecting an operating current of the ballast. This can be an input current and/or an output current. As with the other parameters, the memory can store a ballast current threshold value and he processor that is coupled to the ballast current sensor receives a detected ballast operating current and compares the detected ballast operating current to the stored ballast current threshold value. A ballast operating current status message indicative of the comparing can be generated.

In still another embodiment, an additional sensor, referred herein as a third sensor, can provide for detecting a lamp voltage that is the voltage across the lamp interface when the lamp is received therein. This lamp voltage sensor transmits a sensed arc voltage value corresponding to the detected lamp voltage as either an AC or DC signal. As with the other parameters, the memory stores a threshold arc voltage value and the processor is coupled to the third sensor and receives the transmitted sensed arc voltage value. The processor uses computer executable instructions stored in the memory for performing the method of comparing the sensed arc voltage value with the stored threshold arc voltage value and generating an arc voltage status message responsive to the comparing of the sensed arc voltage value.

This lamp voltage or third sensor can be of any suitable form. In one exemplary embodiment, the lamp voltage sensor is a voltage divider circuit coupled between the first lamp terminal and the second lamp terminal of the lamp interface. The voltage divider circuit transmits an analog AC sensed arc voltage value and the processor receives the analog AC sensed arc voltage value. In some embodiments, an AC to DC converter is coupled to receive the analog AC sensed arc voltage value and generates an analog DC sensed arc voltage value. The processor receives either or both of the AC and DC sensed arc voltage values and can make comparisons and analysis thereon.

In addition to monitoring ballast and lamp operating parameters, a lamp fixture assembly as described herein can also include other lamp assembly parameters in adaptively monitoring and operating of the lamp. For example, a lamp fixture can also include a temperature sensor positioned for detecting an operating temperature of the ballast or of the lamp itself. In such embodiments, the memory would also store one or more temperature threshold values and the processor would be coupled to the temperature sensors to receive a detected ballast or lamp operating temperature. Computer executable instructions can provide for comparing detected operating temperatures to the stored temperature threshold values, and generating temperature status message resulting therefrom.

As described above, each of the sensors can include output interfaces for providing their sensed values to other components, including the processor. In this case, the processor being one of the external components or systems as compared to the ballast, each of which are components of the lamp fixture assembly. Of course, these sensor output interfaces can also be provided directly to output interfaces of the assembly itself as well as the processor within the assembly.

The assembly can also include a plurality of communications output interfaces coupled to the processor for providing messages to external systems, e.g., systems that are external to both the ballast and the other components of the lamp assembly. These can also be either analog or digital interfaces. For example, in one embodiment a first ballast output interface coupled to the first sensor for providing the transmitted sensed arc current value to the processor as well as optionally to an external system communicatively coupled to the first output interface, and a second output interface coupled to the second sensor for providing the transmitted the sensed ballast operating parameter value to the processor as well as optionally to an external system communicatively coupled to the second output interface.

An output communication interface is coupled to the processor for communicating over a coupled communication facility at least one of the generated lamp status message and the ballast status message. The output communication interface can be directly or indirectly coupled to the processor. In one example, not intending to be limited hereto, this can be a serial interface that transmits each of the lamp status message and the ballast status message are each represented as a single bit. Generally, the output communication interface can be any suitable communications interface. For example, this can include, but is not limited to, an I²C bidirectional bus interface, a phase width modulation (PCM) serial bus interface, a bi-directional RS-232 interface, an Ethernet interface, TCP/IP interface, wireless interface, Wi-Fi interface, and BlueTooth® interface, (BLUETOOTH is a registered trademark of Bluetooth SIG, Inc.).

As noted, the processor can be directly coupled to the output communication interface where the processor is configured for such, and possibly where no isolation or data communication formatting or interfacing is required with the desired communication facility. However, it is possible that the output communication interface also include an isolation module for interfacing with the communication facility and or a separate communication module for providing communication connection, protocol conversion, or data interfacing with the coupled communication facility.

In embodiments having an arc current sensor as described above, the arc current sensor can transmit an AC sensed arc current value. The processor can be coupled to directly receive the AC arc sensed current value. Additionally, an AC to DC converter can be coupled between the sensor and the processor to create a DC arc sensed current value. This DC arc sensed current value can also be sent to the processor. The processor can receive the AC and DC sensed arc current values and can be configured with computer executable instructions to generate a DC sensed arc current value and/or a generated DC sensed arc current value.

The computer executable instructions stored in the memory and processed by the processor can include additional lamp fixture processes that can enhance the adaptive monitoring and control nature and capabilities based on the herein described features. These can be of any nature and are not limited by this disclosure. As one exemplary embodiment, the processor can include executable instructions for determining a quantity of output of a received lamp, such as a quantity of light, based on one or more of the sensed ballast and/or lamp operating parameter values. For example, the present system can provide for determining a light output of a gas discharge lamp based on the sensed arc current value and the sensed arc voltage value. In another embodiment, the processor can include executable instructions for determining a percentage of lamp life remaining and generating a message including the determined percentage of lamp life remaining

In some embodiments, a clock is provided for determining a current time of various assembly or system events and time stamping of those events and the various measured values and detected events. The processor is coupled to the clock for receiving the determined current time from the clock and for making and time stamping detected events and values. Computer executable instructions are stored in the memory for performing a method that can utilize these time oriented events and measurements. For example, one method can include detecting the receiving of a new lamp into the lamp interface, and determining from the clock a new lamp time corresponding to the detecting of the new lamp. The method can also include receiving and storing in the memory a new lamp sensed arc current value and/or other lamp fixture parameters as described herein, including both lamp and ballast parameters. In one embodiment, the method can determine an age of the lamp as a function of a difference between a current time and the stored new lamp time, comparing the current sensed arc current value and the current sensed arc voltage value with the stored new lamp sensed arc current value, and based on those comparisons, determine an end of life of the lamp or at least an estimated end of life of the lamp. Then an end of lamp life message indicative of the determined end of life of the lamp can be generated over an output communication interface.

In one exemplary embodiment, an assembly for adaptively monitoring operation of a lamp fixture includes a power input interface for receiving input power from an external power source, and a ballast coupled to the power input interface receiving the received input power and creating lamp power between a first lamp terminal and a second lamp terminal. The created lamp power includes a terminal voltage and a variable lamp current as provided to a lamp interface defined between the first lamp terminal and the second lamp terminal. The lamp interface is configured for receiving a gas discharge lamp for providing light or other energy responsive to receiving lamp power from the first and second lamp terminals. A sensor detects an arc current circulating through a lamp received in the lamp interface, the sensor transmitting a sensed arc current value corresponding to the detected arc current. A clock determines a current time and a memory stores a threshold arc current value. A processor is coupled to the memory, the clock, and the first sensor and the processor receives the determined current time from the clock and the transmitted sensed arc current value from the first sensor.

The processor performs the method of detecting the receiving of a new lamp into the lamp interface, determining from the clock a new lamp time corresponding to the detecting of the new lamp and receiving and storing in the memory a new lamp sensed arc current value. The method also includes determining an age of the lamp as a function of a difference between a current time and the stored new lamp time, comparing the current sensed arc current value and the current sensed arc voltage value with the stored new lamp sensed arc current value, and determining an end of life of the lamp as a function of the comparing to the stored new lamp arc current value. From this, the processor can generate an end of lamp life message indicative of the determined end of life of the lamp. Further, or in the alternative, the processor can be configured with instructions to determine a percentage of lamp life remaining and generate a message including the determined percentage of lamp life remaining.

Of course as described above, the use of the arc current value is only exemplary, as any one or more of the lamp, ballast or lamp fixture operating parameters can be used for determination of the end of lamp life.

A monitoring and reporting system and method as described herein includes microcontroller that monitors a plurality of sensors to monitor different conditions of the electronic ballast and operating conditions of the lamp. In some embodiments, two of the parameters that provide a good indication of the lamp's operation that can be monitored, as discussed above, include:

A. arc current circulating thru the gas when the lamp is operating. A general term for a high intensity electrical discharge occurring between two electrodes in a gaseous medium, usually accompanied by the generation of heat and the emission of light. Arc current circulating thru the gas when the lamp is operating is measured by passing both cathode leads (either cathode's side of the lamp) thru a small toroidal transformer to form single turn opposing windings. In operation the opposing windings cancel out the cathode currents leaving only the arc current as the measured parameter. The toroid itself is a small ferrite core such as those used in transformer driven ballast.[2]

B. lamp voltage between these two electrodes. Because the voltage across the two opposite electrodes can reach several hundreds of volts, a voltage divider is used to scale down this voltage and make its measurable in the order of no more than 5 volts.

By monitoring this scaled down voltage, a condition called “EOL”—End Of Life (of the received lamp) can be detected by using the present disclosed lamp fixture system. Final dangerous operating conditions can happen, when the fluorescent lamp reaches the end of lifetime or at operating conditions leading to thermal instability of the lamp. As a consequence the lamp voltage becomes unsymmetrical or increases. The turn-off threshold because of exceeding the maximum lamp voltage can now be detected via the above mentioned voltage divider.

The above mentioned parameters apply to the lamp's operating characteristics. In some embodiments, the present disclosed lamp fixture system can provide for monitoring other vital functions of the ballast. These can include, but are not limited to:
A. operating voltage of the ballast
B. operating current of the ballast. The present disclosed lamp fixture system is capable of monitoring all phases of the lamp's current changes. For example, striking arc's current and sustained operating current; etc. can be easily monitored. This current is sensed by wrapping a few turns on the toroidal input inductor used to reduce EMI (electromagnetic interference) and sampling its induced voltage for further software or DSP (digital signal processing) analysis using a microcontroller.
C. Operating current of the ballast is in a form of a modified or pure sinusoidal wave due to the switching characteristics of the transistors. Hence, the operating frequency of the ballast can also be monitored.
D. By sensing voltage (A) above and current (B) above power factors, crest factor and most every parameter that relates to ballast operations can also be easily calculated.
E. Operating temperature. The operating temperature of the ballast is a critical indication of its performance; a temperature sensor or plurality of sensors can be monitored via the microcontroller. There are many different types of sensors to measure components and or ambient temperature and their difference and theories of operation are well known and escape the scope of this disclosure. Thermistors are chosen as an example for the present disclosed lamp fixture system, for its low cost and simplicity of operation.

Upon detection of one or more of these parameters, real time dynamic software and digital signal processing can be performed. As such, the present system can report to external devices or systems via serial communication protocols the above mentioned parameters. Sensor specific alert messages are transmitted to the remote systems and or devices.

Because the microcontroller knows the operational status via the parameter values of the ballast, lamp and or combination of both, critical feedback adaptive decisions can be then made and impressed upon the ballast. For example but not limited to:
a) if the temperature of the ballast is too high, shut it down and report;
b) if the arc current is too low or non-existing, report a lamp replacement and shut down the ballast;
c) if the input voltage falls or increases to dangerous levels that can compromise the electronics of the ballast, report and shut down the ballast;
d) if the ballast stopped oscillating due to a component failure, report and shut down the ballast;
e) if the lamp is approaching its EOL, report and shut down the ballast;
f) if one (or both) filaments of the lamp are open, report and shut down the ballast; and
g) if the oscillating frequency of the ballast is out of normal operating range, report and shut down the ballast.

With the present system, the reporting of the ballast and lamp health is independent of the ballast or other circuitry. In other words, even when the ballast is shut down, the status of the systems components and any causes or problems related thereto can and will continue to be reported to the remote system and or devices. Additionally, the ballast can from time to time continue monitoring the stimuli and reacting accordingly. For example, if the ballast was operating too hot, it can be re-powered after the heat decreased to safe levels.

In other embodiments, the disclosed lamp fixture system can analyze and report the amount of light or energy emitted by the lamp by analyzing the available parameters such as the arc current and arc voltage. For example, when a lamp is new and rated at 17 W, its initial arc current and arc voltage can be recorder. During the operation of the lamp, these parameters are monitored and reported over time. From this data, the percentage of “life” left on the lamp can be determined and reported.

Similarly, in some embodiments, the disclosed lamp fixture system can determined the quantity of hours that a lamp is operated and report when a replacement is due based on a comparison against a predetermined maintenance threshold for lamp hours. There are many instances, i.e. hospitals using germicidal lamps that require UV germicidal lamps replacement every 1,000 of operation.

### Exemplary Embodiments

Referring now to the exemplary embodiments as shown in the attached drawings.

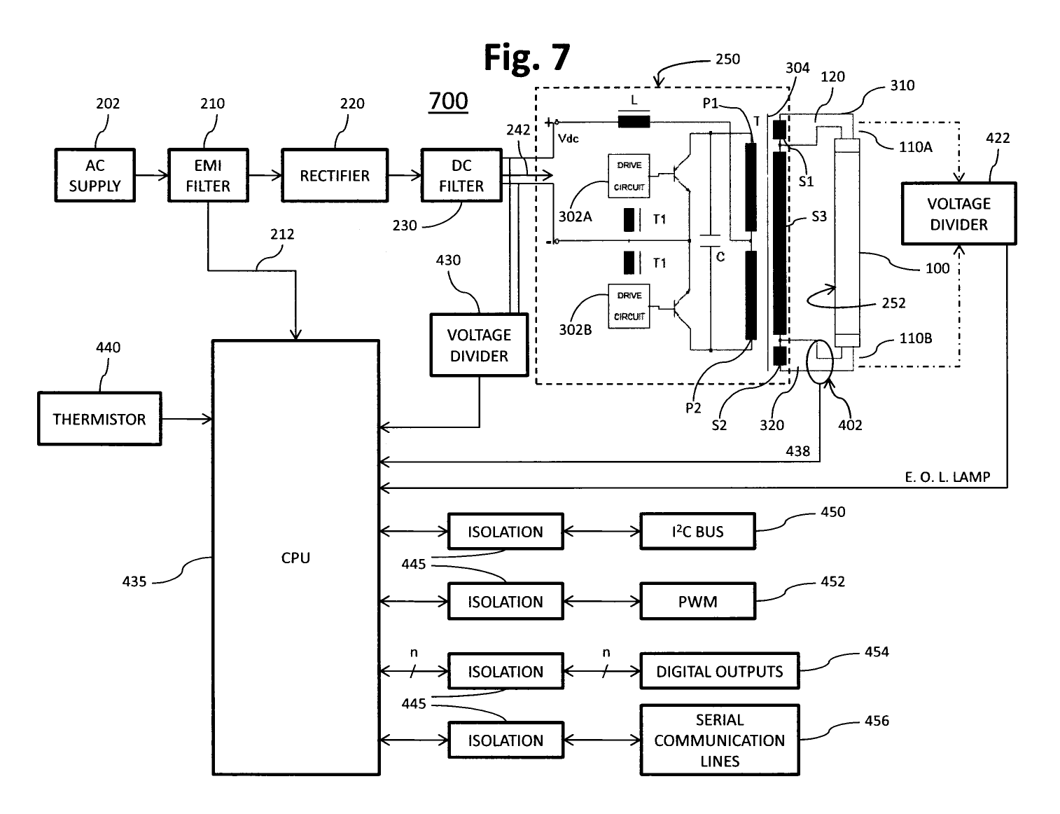

FIG. 7 is a schematized block diagram of an exemplary embodiment of the disclosed lamp fixture system 700 showing EMI filter 210, rectifier 220, and DC filter 230 that provides input power to ballast 250. In this exemplary embodiment, an optional voltage divider 422 is coupled across the lamp interface 252 between the two cathodes 110A and 110B to provide a means of detecting the arc voltage across the lamp as described above. This can be one parameter input that can be used by the processor 435 that is monitored and that can determine an operational status of the ballast 250 and/or the lamp 100, such as to detect end of life lamp. Current transducer 402 is coupled in this example to the non-intrusively coupled to cathode leads 320 from secondary winding S2 that provides lamp power to cathode 110B is used to measure the lamp's arc current during operation. The output of the current transducer 402 is voltage feedback 438 that is provided as an analog AC signal to microcontroller 435. The microcontroller 435 can utilize this analog AC signal 438 to determine the arc current of the lamp. In this exemplary embodiment, an optional thermistor 440 is used to measure and monitor the operating temperature of the ballast 250, which is typically placed proximate to the core 304. A second voltage divider 430 is coupled to the input power 242 as provided by the DC filter 230 to the ballast 250 to provide the microcontroller 435 with a measured value of the voltage of the input power 242 to the ballast 250. Additionally, as an optional input into the microcontroller 435, a measurement of the power provided by the AC power supply 202 as measured at the EMI filter 210 can be provided as input power measurement 212.

The CPU 435 has four exemplary illustrated communication outputs. A first communication output is provided to an output interface 450 for interfacing with a bidirectional I²C bus. A second communication output module 452 is a PWM (phase width modulation) output interface module. In one embodiment, this interface 452 can provide a simple communication of the several states of the ballast as will be discussed in further detail below. A third communication interface 454 is provided to provide one or more digital outputs that can be utilized to communicate a message that includes various digital messages including, but not limited to, the several states of the ballast. A fourth communication output interface module 456 is a bi-directional RS-232, Ethernet or similar data communication interface that can be utilized for communicating output messages that also indicate several states of the ballast. The functions and operations of these communications output interfaces 450, 452, 454, and 456 will be explained in greater detail below.

As shown in FIG. 7, one or more optical and/or magnetic isolation modules 445 can be provided to provide a bi-directional isolation to all digital and analog communication lines or facilities as coupled to the microcontroller 435. This module 445 can be removed if no electrical isolation is required between the ballast's power supply 700 and external or secondary systems to which the disclosed lamp fixture system 700 is connected. Such isolation modules 445 are well known to persons of the trade and they do not require explanation in the context of the disclosure.

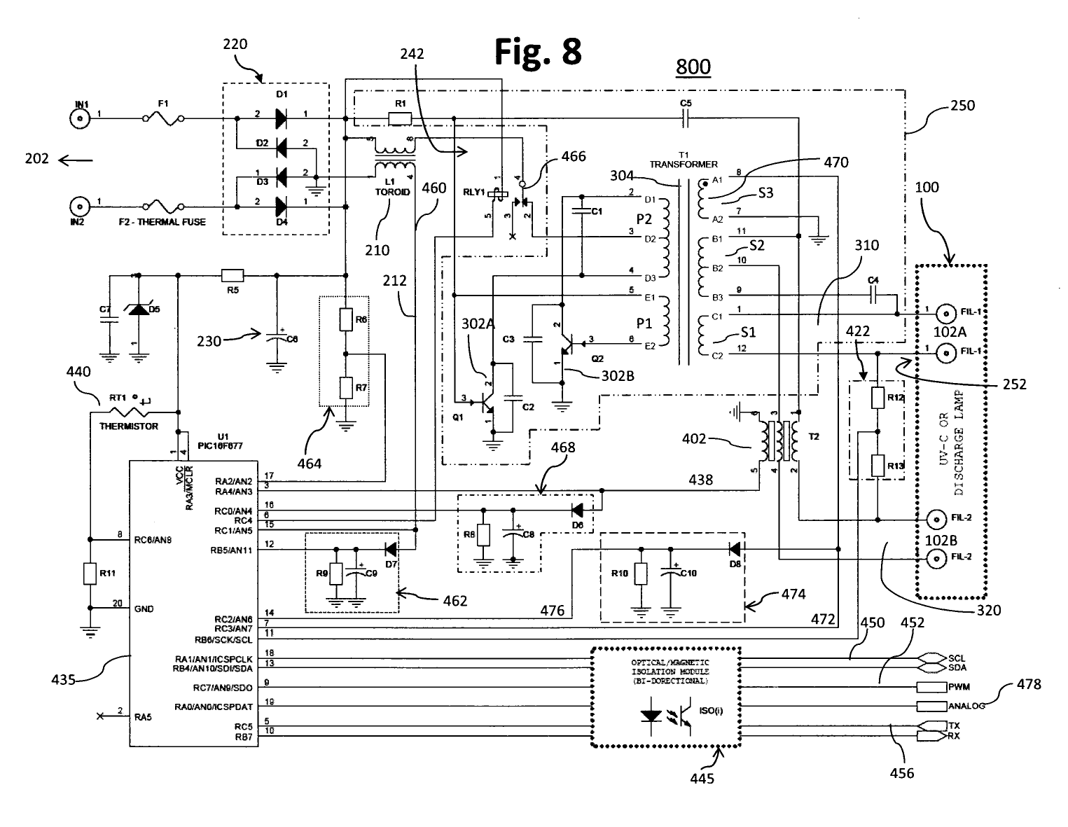

FIG. 8 is the electronic schematic of an exemplary embodiment of the disclosed lamp fixture system 800. The rectifier 220 receives input power from power supply 202 (not shown) and rectifies the AC power using diodes D1, D2, D3, and D4 that make a full wave rectification bridge as known in the art. EMI filter 210 includes a toroidal core L1 but that can also include an output from an additional winding 460 for providing a measured input voltage signal 212 to the microcontroller 435. This provides the ability to monitor the status of the input power to the ballast 250 and in particular to the ballast stages 302A and 302B. This output 212 is provided to microcontroller (CPU) 435. CPU 435 monitors alternating changes of the current 460 via A/D (analog to digital) input pin 15. This same alternating signal 460 from additional winding 46 can be rectified by network 462 (shown as resistor R9, Capacitor C9 and diode D7) that converts it into a pure DC signal that is fed to pin 12 of microcontroller 435. The DC filter 230 is provided by capacitor C6. The DC operating voltage for the ballast 250 that is present at DC filter 230 can be scaled down by resistor divider network 464 (shown as resistors R6 and R7) for further analysis by microcontroller 435. This measured value can be used to monitor that input power 242 of the ballast 250 is within safe operating limits. If the voltage of falls below a certain voltage or exceeds a certain voltage, the CPU can operate to disconnect power to the ballast 250. This shutting down of the ballast 250 can be accomplished by operation of a relay 466 (electronic or electro-mechanical) to disconnect input power 242 from the ballast stages 302A and 302B based on a control via CPU pin 6.

The thermistor 440 translates the detected operating temperature of the ballast 250 into an analog voltage that is provided to the CPU as shown. If the ballast 250 is operating outside of the temperature safety area operation of the ballast 250, the CPU can also shut down the input power 242 to the ballast 250. The operating or arc voltage between cathodes 110A and 110B (e.g., at the lamp interface 252) can be scaled down by voltage divider 422 and sampled by the A/D input pin 11 of CPU 435. It is well known to persons of the trade that the arc voltage increases as the lamp 100 ages. Therefore, monitoring of the arc voltage by the voltage divider 422 can be used by the CPU 435 to report and shut down the ballast 250 when the lamp 100 received within the lamp interface 252 reaches it's EOL (end of life).

Cathode filament 110B leads 320 are then passed thru current transducer 402. With both cathode leads 320 passing through the current transducer 402, the opposing windings thereof cancel out the cathode currents leaving only the arc current as the measured parameter in the form of an analog alternating voltage that can be provided to pin 3 (A/D input) of microcontroller 435. However, this same waveform can be rectified by network 468 and fed to microcontroller 435 pin 16 in the form of an analog DC voltage. These voltages are used to determine the actual operating current of the lamp, both dynamically and in its steady state. Microcontroller 435 can use this information as well as the lamp voltage between the cathodes (arc voltage) to calculate the exact operating parameters of the lamp at any given time. If the lamp 100 is bad or not ignited, this is interpreted by a very low lamp current measured via transducer 402 as explained above.

Further data for the operating point of the ballast 250 is obtained via sampling secondary winding S3 which is also identified as 470 (winding A1-A2). This third secondary winding S3 or 470 is not electrically coupled to the lamp cathodes but is magnetically coupled to the core 304. The voltages induced in this sensor winding 470 is provided either directly or indirectly to CPU 435 in the form of alternating (AC) voltage 472 or as a DC voltage 476 when this same waveform is rectified by network 474. These third secondary induced voltages from the core 304 of the ballast 250 can be used to determine the actual operating conditions of the ballast 250, and used among other calculations, to calculate the resonating (operating) frequency of the ballast 250. If the ballast 250 is not oscillating, the CPU 435 can immediately interpret this status can be used for reporting and controller of the ballast 250 and/or the lamp 100. The third secondary winding 470 can detect variations in the induced voltage and current form the ballast states 302A and 302B, as well as changes in the induced voltages and currents in secondary windings S1 and S2, the and the loads placed thereon at cathodes 110A and 110B, or between the two as in the lamp interface 252 and the lamp 100 received therein.

Optical and or magnetic isolation modules 445 provide bi-directional isolation to all digital and analog communication interfaces 450, 452, 478, and 456 that provide information on the operation of the ballast 250 and lamp 100 to any external systems. These isolation modules 455 to one or more of the communication interfaces 450, 452, 478, and 456 can be removed if not electrical isolation is required between the system 800 and external systems attached thereto.

An I²C bidirectional bus interface 450 was designed by Philips in the early '80s to allow easy communication between components which reside on the same circuit board. Philips Semiconductors migrated to NXP in 2006. The name I²C translates into “Inter IC”. Sometimes the bus is called IIC or I²C bus. The original communication speed was defined with a maximum of 100 Kbit per second and many applications don't require faster transmissions. For those that do there is a 400 Kbit fastmode and—since 1998—a high speed 3.4 Mbit option available. Recently, fast mode plus, a transfer rate between this has been specified. I²C interface 450 is not only used on single boards, but also to connect components which are linked via cable. Simplicity and flexibility are key characteristics that make this bus attractive to many applications. Most significant features include: only two bus lines are required; no strict baud rate requirements like for instance with RS232, the master generates a bus clock; simple master/slave relationships exist between all components. Each device connected to the bus is software-addressable by a unique address; I²C interface 450 is a true multi-master bus providing arbitration and collision detection.

An analog signal interface 478 can also be provided. The analog signal interface 478 can include a voltage that is indicative of one or more of the different states of the ballast 250 and/or lamp 100 as explained further down.

Due to the bi-directional nature of the communication interfaces and communication lines/facilities, data can be transmitted to the system 800, for example, to adjust the type of lamp 100 connected, its operating parameters, etc. making the disclosed lamp fixture system 700 a truly adaptive system. For example, as the lamp 100 ages the threshold of current for detecting a non-operating (non-ignited) lamp 100 can be adjusted.

These adjustments enable the present system 800 to be adaptive by utilizing these intelligent adapting parameter decision algorithms which can be implemented locally via microcontroller 435 or externally via serial communication port 456, or I²C bus 450, by ways of example, and not intending to be limited thereto. When the adaptive algorithm resides in microcontroller 435 and adjustments are implemented internally to CPU 435, the ballast 250 and or system 800 can be used as an adaptive intelligent stand-alone gas discharge lamp fixture powering system.

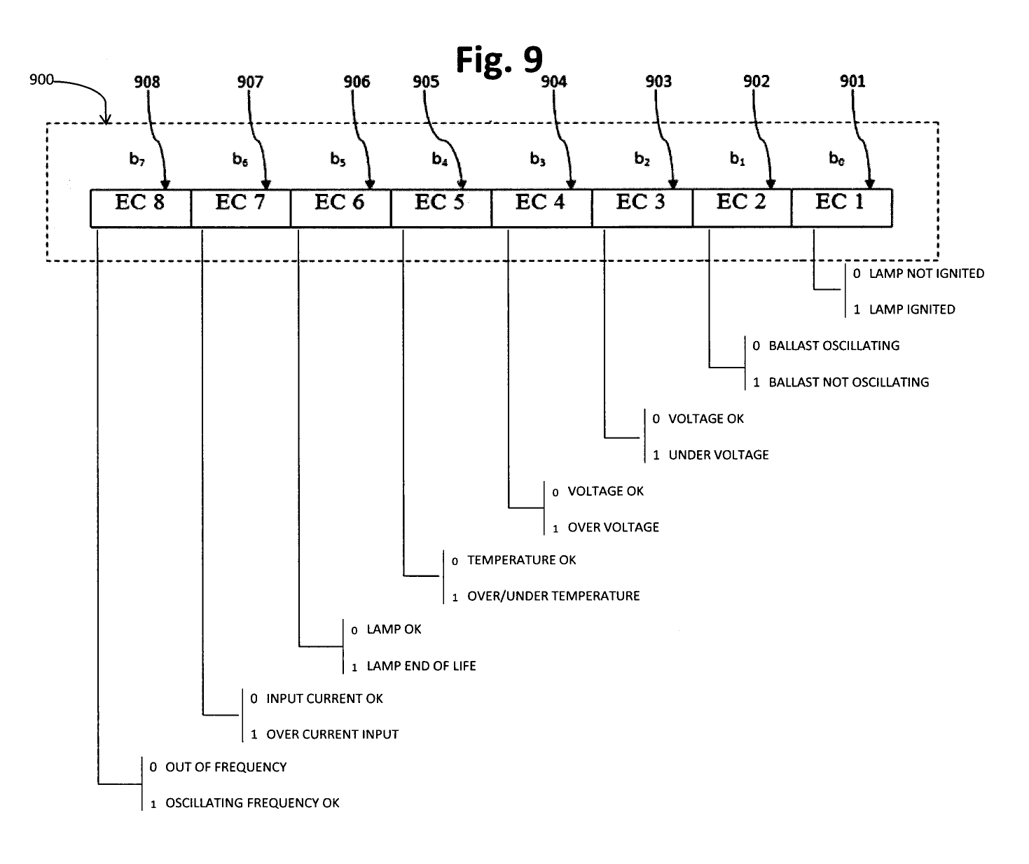

FIG. 9 is a software byte description showing the bit allocation for different status codes of an exemplary embodiment of the disclosed lamp fixture system, and each one is explained in detail below. Fault conditions can be determined in this exemplary embodiment as:

A) an operating over/under temperature detection (monitored via thermistor 440 in the form of a DC voltage determined by the resistor divider's network RT1 and R11) and reported by bit b₄ EC5 905 of status byte 900. As a representing example, under-temperature threshold can be set as −10° C.; over-temperature threshold can be set to +90° C.

B) Power supply under voltage detection (monitored via divider network 464) and reported by bit b₂ EC3 903 of status byte 900. As a representing example, under-voltage threshold can be set as +18 VAC.

C) power supply over voltage detection (monitored via resistor network 464) and reported by bit b₃ EC4 904 of status byte 900; over-voltage threshold can be set to +32 VDC.

D) a bad lamp 100 or lamp 100 not ignited (monitored via current transducer 402 and associated circuitry 468) and reported by bit b₀ EC1 901 of status byte 900; this can be determined, as a representative example, by monitoring that DC voltage output of network 468 does not fall below a minimum DC voltage threshold such as +1.5 VDC. If the measured voltage falls below this value, it is safe to assume that the lamp has not been ignited. i.e. due to a burnt filament.

E) non-oscillating or non-functional ballast (monitored via auxiliary winding 470 A1-A2 (S3) and associated circuitry 474) and reported by bit b₁ EC2 902 of status byte 900; this can be determined, as a representative example, by monitoring that DC voltage output of network 474 does not fall below a minimum DC voltage threshold such as +1.5 VDC. If the measured voltage falls under this value, it is safe to assume that the ballast is not oscillating.

F) End of life for lamp 100 (monitored via resistor divider 422) and reported by bit b₅ EC6 906 of status byte 900; this can be determined, as a representative example, by monitoring that DC voltage output of network resistor divider 422 does not exceed a maximum DC voltage threshold such as +3.75 VDC. If the measured voltage exceeds this value, it is safe to assume that the lamp is reaching its end of life. It is well known that discharge lamps increase the voltage of the cathode 110A and 110B as the lamp 100 ages in order to maintain an arc.

G) Over operating current of the ballast and/or ballast-lamp combination (monitored via EMI auxiliary winding 460 and associated circuitry 462) and reported by bit b₆ EC7 907 of status byte 900; this can be determined, as a representative example, by monitoring that DC voltage output of network 462 does not exceed a maximum DC voltage threshold such as +2.75 VDC. If the measured voltage exceeds this value, it is safe to assume that the ballast 250 is operating at higher than normal current draw due to a number of reasons.

H) Oscillating frequency of ballast 250 out of range (monitored via auxiliary winding 470 A1-A2 (S3) and pin 7 of microcontroller 435) and reported by bit b₇ EC8 908 of status byte 900. This can be determined, by measuring and monitoring the frequency presented to the microcontroller 435; say the ballast 250 is supposed to operate at 38 KHz +/−10% (arbitrarily set as an exemplary number); if the measured frequency output of winding 470 is greater than 41.8 KHz this is interpreted and reported as an over-frequency operation of the ballast. In contrast, if the measured frequency output of winding 470 is lower than 34.2 KHz this is interpreted and reported as an under-frequency operation of the ballast 250.

These are but a few of the exemplary methods and processes that can be implemented in computer executable instructions that are operated on by CPU 435 for adaptively monitoring and controller the operation of a gas lamp powering system.

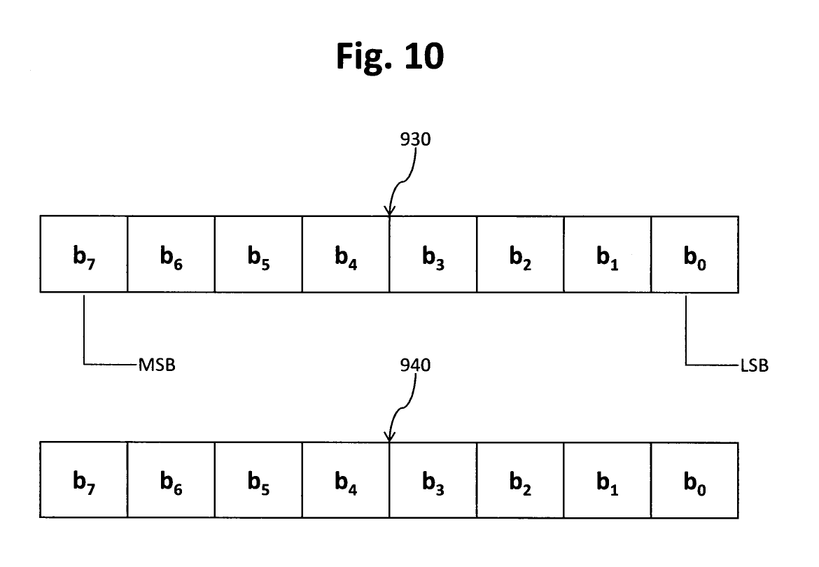

FIG. 10 is a two byte description operating current and voltage of the lamp 100 of an exemplary embodiment of the disclosed lamp fixture system 700 or 800 by ways of example, sent after status byte 900. Byte 930 represents the digital value of the current of operating lamp 100 and consecutive byte 940 represents the digital value of the operating arc voltage of the lamp 100 as measured by voltage divider 422.

Digital communication interface lines TX-RX 456 are communication lines for transmitting and receiving bi-directional information to and from the systems such as 700 and 800, for example transmission of digital bytes 900, 930 and 940. Alternatively these two lines or any two additional output lines from microcontroller 435 can be used as digital indicators to externally communicate parameter status.

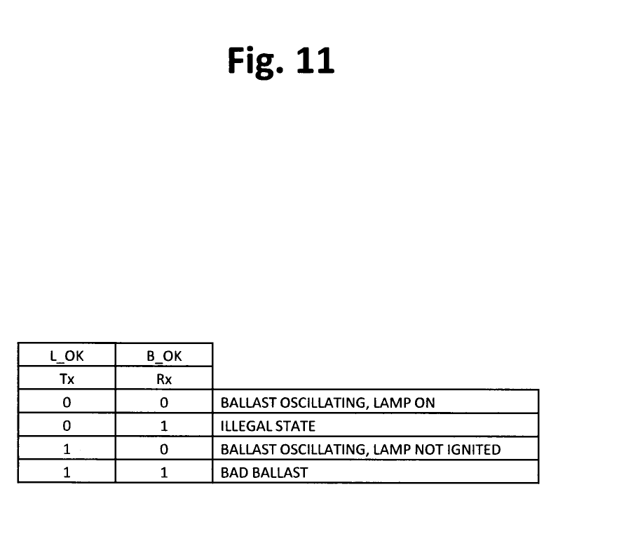

FIG. 11 shows four different status codes of an exemplary embodiment of the disclosed lamp fixture system corresponding to the two above mentioned digital output lines. As shown in the chart of FIG. 11, the lamp ok L_OK and the ballast ok B_OK can represent four states by a simple combination of two digital lines.

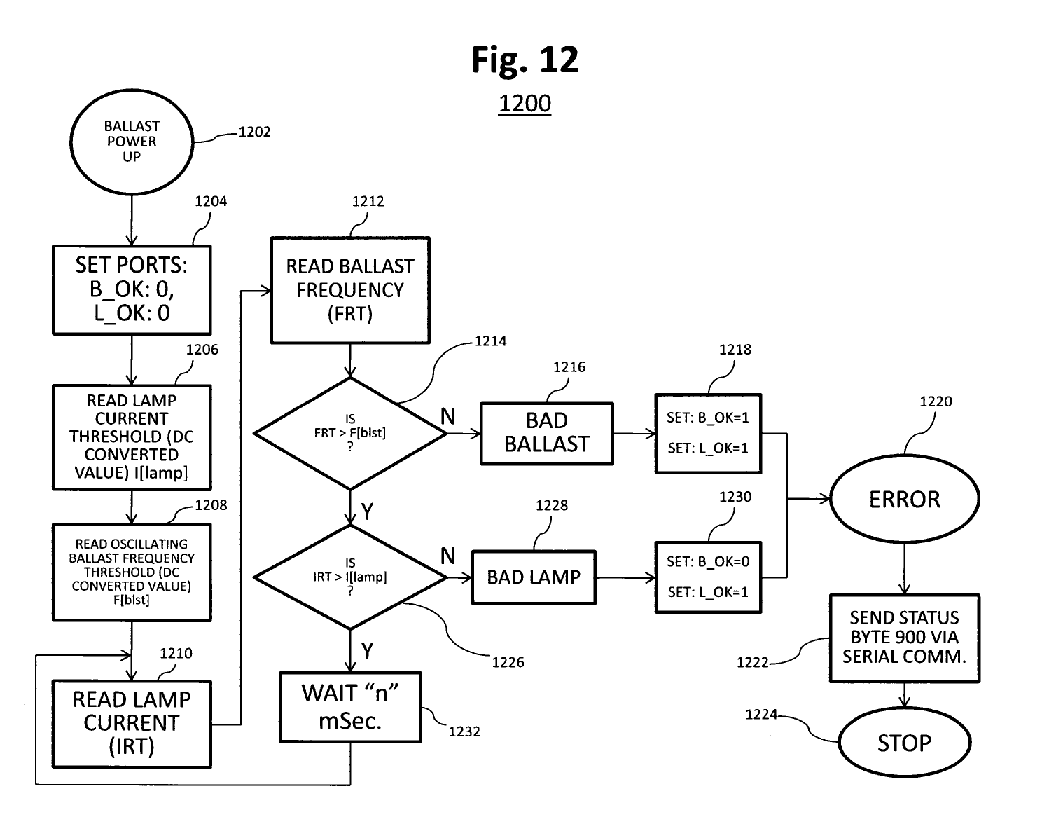

FIG. 12. is a software flow chart 1200 exemplary embodiment of the disclosed lamp fixture system 700, 800 using two digital lines and digital communications to message an external system of error events to implement logic state chart of FIG. 11. When the ballast 250 is powered up in process 1202, the process first forces both digital output lines 454 L_OK (lamp operating OK) and B_OK (ballast operating OK) to a low “0” state that indicates all is working normally as provided in process 1204. This is indicated in FIG. 11 as state 0-0 (ballast oscillating, lamp on). Immediately following that, two parameters stored in non-volatile memory (internal to microcontroller 435) are fetched or retrieved in process 1206. The first parameter is the lamp current threshold corresponding to that of a normally operating ballast/lamp, converted to a DC value by a network 468, and called I[lamp]. A second parameter retrieved in process 1208 is the ballast oscillating threshold corresponding to that of a normally operating ballast/lamp, converted to a DC value by a network 474, and called F[blst]. Note that F[blst] is a DC voltage directly proportional to the frequency of oscillation of the ballast 250.

Once these two parameters are fetched from memory in process 1206 and 1208, process 1210 provides that the microcontroller 435 samples value IRT (meaning current I in Real Time) in process 1212 via A/D input port RC0/AN4 and value FRT (meaning Frequency in Real Time) in process 1212 via A/D input port RC2/AN6 of microcontroller 435. The method continues in process 1214 wherein there is a comparison of the FRT to F[blst]. If FRT is lower than F[blst] it means the ballast is not oscillating or out of frequency (this can be easily detected in software). As such, it is determined in process 1216 that the ballast is bad and in process 1218 the parameters are set as B_OK=1 and L_OK=1 as stated by state 1-1 in logic state chart of FIG. 11. At this point, the method determines there is an error in process 1220 and the process 1222 provides that status byte 900 is serially transmitted and the method ends or stops at process 1224. If process 1214 determines that the FRT is higher or equal to F[blst] that means that the ballast is properly oscillating, and microcontroller 435 then proceeds to now compare IRT to I[lamp], the lamp current in process 1226. If process 1226 determines that the IRT is lower than I[lamp] it means the lamp is not ignited, or filament(s) burnt, etc. (these different causes can be easily discriminated in software) and it is determined in process 1228 the lamp is bad. Process 1230 then sets parameter bits B_OK=0 and L_OK=1 as stated by state 1-0 in logic state chart of FIG. 11. And the error and reporting processes of 1220 and 1222 are made. If in process 1226 the IRT is higher or equal to I[lamp], then the lamp is properly ignited and the method continues to process 1232 wherein the microcontroller 435 executes a wait period of “n” milliseconds and proceeds to sample IRT and FRT repeating the process in an infinite loop. It is clear that several other parameters, such us under/over voltage detection, lamp's end of life, over/under temperature etc. can be monitored, compared and detected using same or similar algorithm or method 1200.

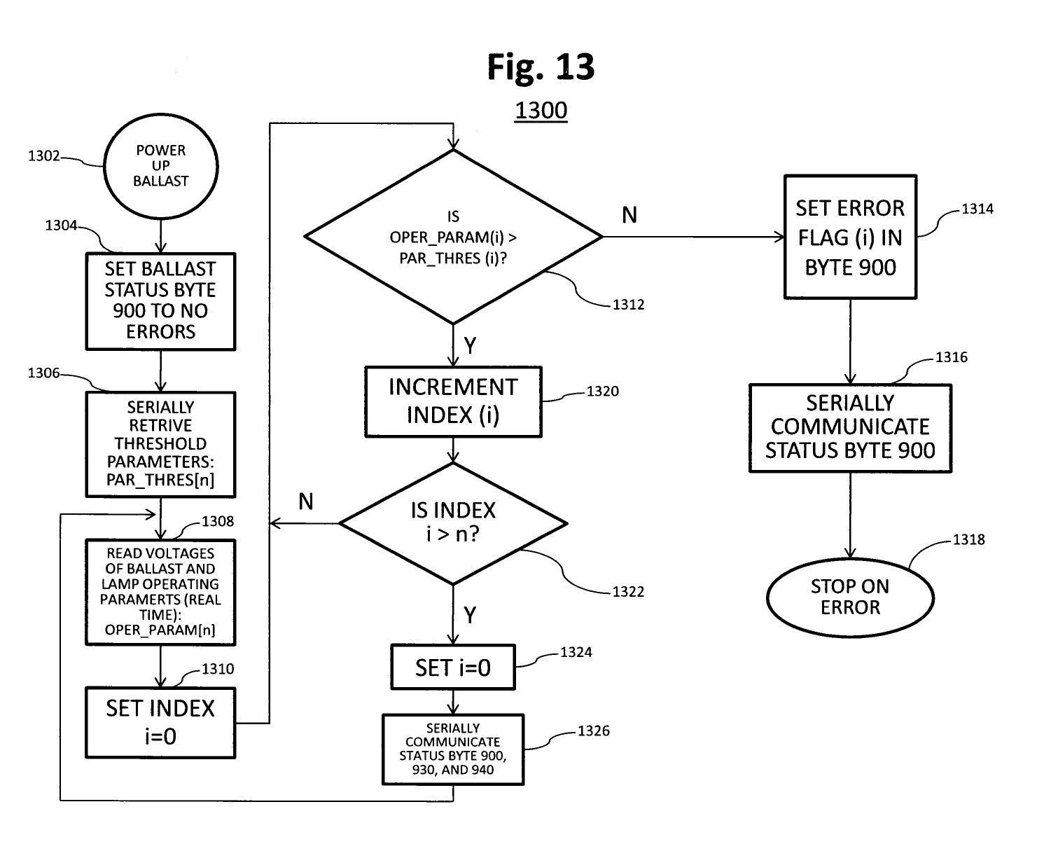

FIG. 13 is another software flow chart exemplary embodiment of the disclosed lamp fixture system method of operation 1300 that uses serial communication protocols via communication interfaces 450, 452, 456 (and the facilities connected thereto) independently or simultaneously to receive threshold parameters, adjusts threshold parameters accordingly and remotely messages error events via same communication lines. In this exemplary method 1300, upon powering up the ballast in process 1302, in process 1304 the ballast status byte 900 is set to no errors as a reset. In process 1306, the microcontroller 435 communicates to an external system via its serial communication interfaces 450 and/or 452 and/or 456 to fetch threshold operating parameters array of variables PAR_THRES(n) where n is the number of parameters to retrieve, i.e. 1,2,3, 4 etc. Once the bidirectional handshake is complete, microcontroller 435 sets corresponding bits of status byte 900 in process 1304 to show all operation is OK, i.e. as binary byte 0b10000001 indicating a good status of the ballast with lamp ignited.

Afterwards, a process index is set in process 1310 and the microcontroller 435 proceeds to sequentially sample all analog inputs via its A/D ports in process 1308, assigning a digital value of each input to array of variables OPER_PARAM(n). As an example, OPER_PARAM(3) could correspond to DC voltage translated lamp current read via A/D port RC0/AN4 in the exemplary implementation of FIG. 7. Now microcontroller 435 proceeds in process 1312 to compare all n parameters to detect out of range parameters. In the above example, if OPER_PAR(3) is less than PAR_THRES(3) this is interpreted as a non-ignited lamp, which will lead to bit 0 of 900 to be set to 0 in process 1314 indicated as a lamp not ignited. If any error bit is set, this error condition is reported in process 1316 by means of status byte 900 via serial communication lines, and ballast operation is interrupted in process 1318. If process 1312 determines there are no errors and the ballast is properly operating, process 1320 provides that index (i) is incremented to compare the next value. Process 1322 checks to see if all channels have been sampled (i>n) and if they have, process 1324 provides that index n is reset and status byte 900 as well as digital value bytes 930 and 940 are transmitted serially via digital outputs 452 and/or 452 and/or 456 in process 1326. The method repeats itself until an out of range condition is detected and reported as above. PAR_THES(n) are dynamically communicated in real time, what leads to real time updates that can be changed externally as the lamp ages, environmental conditions change, by ways of examples.

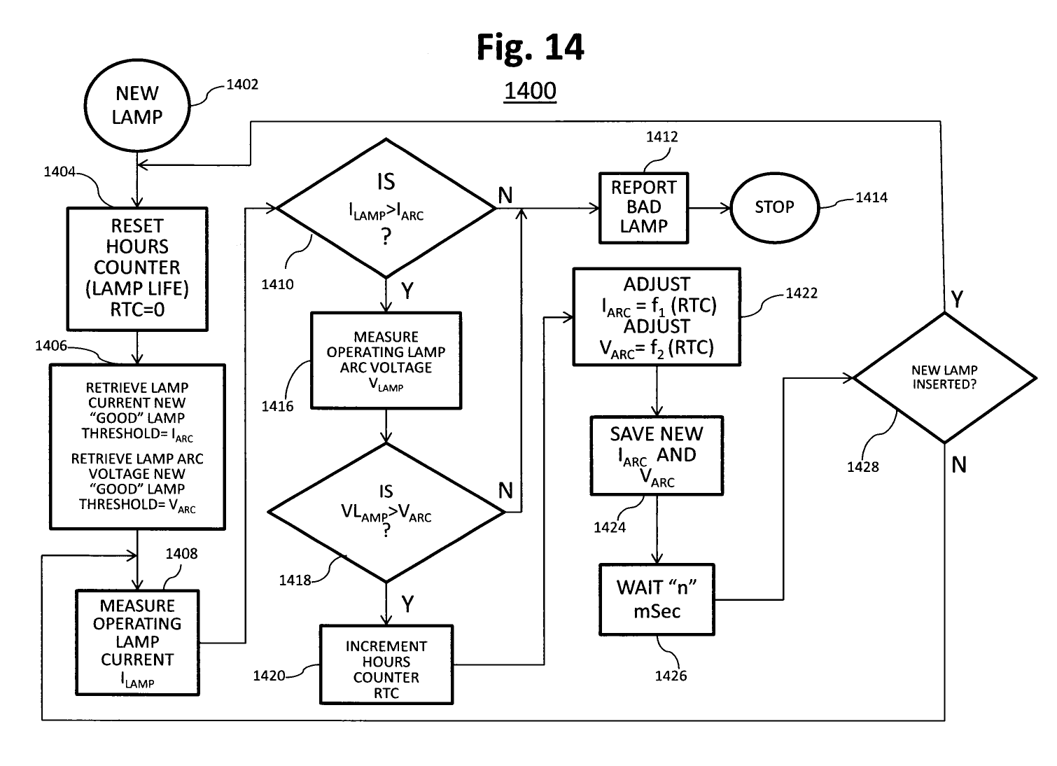

FIG. 14 provides an exemplary flow of a method 1400 for determining a life of a lamp. The method 1400 starts in process 1402 when a new lamp is detected or inserted. Process 1404 resets the hour counter for the lamp as lamp life RTC=0. Process 1406 then retrieves a good lamp threshold for arc current value of I_{ARC} and arc voltage value V_{ARC}. Next the method measures the current arc current values of the operating lamp in process 1408 and this measured value is compared to the threshold value in process 1410. If the measured arc current value is less than the threshold arc current value, then the lamp is reported in process 1412 as being bad and the process stops in process 1414. If process 1410 determines that the measured arc current value is greater than the threshold arc current value, then process 1416 retrieves the measured arc voltage value and this is compared in process 1418 with the threshold arc voltage value. If the measured arc voltage value is less than the threshold value, the lamp is bad and processes 1412 and 1414 are engaged. If process 1418 determines that the measured arc voltage value is greater than the threshold value, then the method continues to process 1420 wherein the hour counter is incremented, which could be limited or configured to only be incremented after the lapse of a predetermined period of time such as an hour. Next in process 1422 the I_{ARC} and V_{ARC} are adjusted with predetermined functions and saved in process 1424 as the new values. The method continues in 1426 by waiting a predetermined amount of time and the method returns to process 1408 for continued monitoring of the lamp during its operation, unless it is determined in process 1428 that a new lamp is inserted.

### Computer Operating Environment

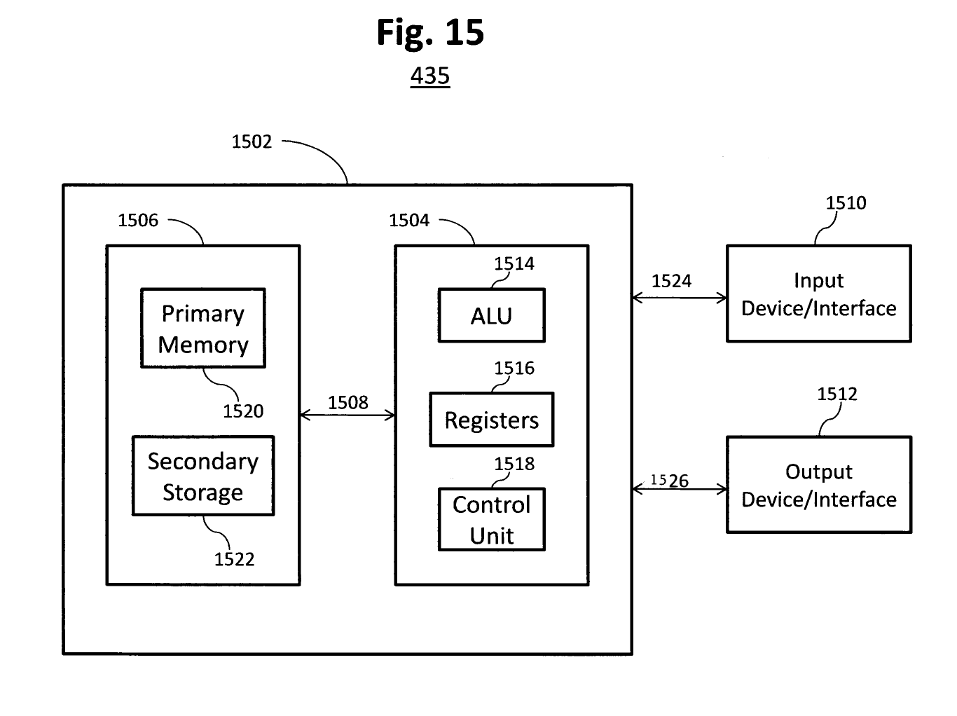

Referring to FIG. 15, an operating environment for an illustrated embodiment of one or more lamp fixture assemblies or systems for providing powering to gas discharge lamps as described herein is CPU 435 with a computer 1502 that comprises at least one high speed central processing unit (CPU) 1504, in conjunction with a memory system 1506 interconnected with at least one bus structure 1508, an input device 1510, and an output device 1512. These elements are interconnected by at least one bus structure 1508.

The illustrated CPU 1504 for an RFID semiconductor chip is of familiar design and includes an arithmetic logic unit (ALU) 1514 for performing computations, a collection of registers for temporary storage of data and instructions, and a control unit 1516 for controlling operation of the CPU 435. Any of a variety of processors, including at least those from Digital Equipment, Sun, MIPS, Motorola, NEC, Intel, Cyrix, AMD, HP, and Nexgen, is equally preferred but not limited thereto, for the CPU 1504. This illustrated embodiment operates on an operating system designed to be portable to any of these processing platforms.

The memory system 1506 generally includes high-speed main memory 1520 in the form of a medium such as random access memory (RAM) and read only memory (ROM) semiconductor devices that are typical on an RFID semiconductor chip. However, the present disclosure is not limited thereto and can also include secondary storage 1522 in the form of long term storage mediums such as floppy disks, hard disks, tape, CD-ROM, flash memory, etc., and other devices that store data using electrical, magnetic, and optical or other recording media. The main memory 1520 also can include, in some embodiments, a video display memory for displaying images through a display device (not shown). Those skilled in the art will recognize that the memory system 1506 can comprise a variety of alternative components having a variety of storage capacities.

Where applicable, while not typically provided on RFID tags or chips, an input device 1510, and output device 1512 can also be provided. The input device 1510 can comprise any keyboard, mouse, physical transducer (e.g. a microphone), and can be interconnected to the computer 1502 via an input interface 1524 associated with the above described communication interface including the antenna interface for wireless communications. The output device 1512 can include a display, a printer, a transducer (e.g. a speaker), by way of examples, and be interconnected to the computer 1502 via an output interface 1526 that can include the above described communication interface including the antenna interface. Some devices, such as a network adapter or a modem, can be used as input and/or output devices.

As is familiar to those skilled in the art, the CPU 435 further includes an operating system and at least one application program. The operating system is the set of software which controls the computer system's operation and the allocation of resources. The application program is the set of software that performs a task desired by the user, using computer resources made available through the operating system. Both are typically resident in the illustrated memory system 1506 that can be resident on the RFID semiconductor chip. These can include the tag reader system with computer implementable instructions stored in its memory that are accessible by and executable by the processor for performing one or more of the tag reader methods and means as described herein. Also, this can include the timing system with computer implementable instructions stored in its memory that are accessible by and executable by its processor for performing one or more of the timing system methods and means as described herein.

In accordance with the practices of persons skilled in the art of computer programming, the present disclosure is described below with reference to symbolic representations of operations that are performed by the CPU 435. Such operations are sometimes referred to as being computer-executed. It will be appreciated that the operations which are symbolically represented include the manipulation by the CPU 1504 of electrical messages representing data bits and the maintenance of data bits at memory locations in the memory system 1506, as well as other processing of messages. The memory locations where data bits are maintained are physical locations that have particular electrical, magnetic, or optical properties corresponding to the data bits. One or more embodiments can be implemented in tangible form in a program or programs defined by computer executable instructions that can be stored on a computer-readable medium. The computer-readable medium can be any of the devices, or a combination of the devices, described above in connection with the memory system 1506.

The present system provides not only for the monitoring of operating parameters but also the messaging of those parameters and the results of comparisons of the parameters with thresholds that can be faults or other predetermined criteria that needs to be monitored or reported. Although there are many commercial electronic fluorescent ballasts in the market, none actually reports externally and remotely vital functions of its operating conditions.

From the foregoing disclosure, it will be appreciated that the present disclosed lamp fixture system provides numerous advantages prior lamp fixture powering systems, and is not subject to the disadvantages of the aforementioned antecedents of the disclosed lamp fixture system. The advantage features include, but are not limited to, one or more of the following for providing a remote reporting message: simple to use, well suited for economical mass production fabrication, that indicates every operating aspect of a fluorescent lamp externally connected to the ballast without physical contact with the lamp and without electrical connection with the lamp, can enable the monitoring of an existing ballast and lamp combination at a remote location and/or system; and is capable of monitoring more than one condition in need of oversight is an additional aspect of the present disclosed lamp fixture system.

When describing elements or features and/or embodiments thereof, the articles “a”, “an”, “the”, and “said” are intended to mean that there are one or more of the elements or features. The terms “comprising”, “including”, and “having” are intended to be inclusive and mean that there can be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps can be employed.

What is claimed is:

1. An assembly for adaptively monitoring an operation of a gas discharge lamp fixture, the assembly comprising:
a power input interface for receiving input power from an external power source;
a ballast coupled to the power input interface receiving the received input power and creating lamp power between a first lamp terminal and a second lamp terminal, the created lamp power including a terminal voltage and a variable lamp current;
a lamp interface defined between the first lamp terminal and the second lamp terminal for receiving a gas discharge lamp for providing light responsive to receiving lamp power from the first and second lamp terminals;
a first sensor for detecting an arc current circulating through a lamp received in the lamp interface, the first sensor transmitting a sensed arc current value corresponding to the detected arc current;
a second sensor associated with the ballast for detecting an operating parameter of the ballast, the second sensor transmitting a sensed ballast operating parameter value corresponding to the ballast operating parameter;
a memory for storing a threshold arc current value, a threshold ballast operating parameter value, and computer executable instructions; and
a processor coupled to the memory, the first sensor and the second sensor, the processor receiving the transmitted sensed arc current value from the first sensor, and the sensed ballast operating parameter value from the second sensor, the processor receiving from the memory and executing the computer executable instructions for performing the method of:
receiving and storing the sensed arc current value and the sensed ballast operating parameter value;
comparing the sensed arc current value with the stored threshold arc current value;
generating a lamp status message responsive to the comparing of the sensed current value;
comparing the sensed ballast operating parameter value with the stored threshold ballast operating parameter value; and
generating a ballast status message responsive to the comparing of the sensed ballast operating parameter value.

2. The assembly of claim 1, further comprising:
a first output interface coupled to the first sensor for providing the transmitted sensed arc current value to an external system communicatively coupled to the first output interface; and
a second output interface coupled to the second sensor for providing the transmitted the sensed ballast operating parameter value to an external system communicatively coupled to the second output interface.

3. The assembly of claim 1, further comprising:
an output communication interface coupled to the processor, the output communication interface configured for communicating over a coupled communication facility at least one of the generated lamp status message and the ballast status message.

4. The assembly of claim 3 wherein the output communication interface is a serial interface and wherein each of the lamp status message and the ballast status message are each represented as a single bit.

5. The assembly of claim 3 wherein the output communication interface is selected from the group consisting of an I2C bidirectional bus interface, a phase width modulation (PCM) serial bus interface, a bi-directional RS-232 interface, an Ethernet interface, TCP/IP interface, wireless interface, Wi-Fi interface, and BlueTooth® interface.

6. The assembly of claim 3 wherein the output communication interface includes an isolation module for interfacing with the communication facility.

7. The assembly of claim 1, further comprising an input interface coupled to the memory for receiving the threshold arc current value and the threshold ballast operating parameter value from an external source.

8. The assembly of claim 1 wherein the input power is selected from the group consisting of alternating current (AC) and direct current (DC).

9. The assembly of claim 1 wherein the ballast includes a transformer having a primary winding for receiving at least a portion of the input power, a first secondary winding coupled to the first lamp terminal, a second secondary winding coupled to the second lamp terminal.

10. The assembly of claim 9 wherein the second sensor includes a non-lamp powering secondary winding of the transformer, and wherein the detected ballast operating parameter is selected from the group consisting of a voltage and a frequency.

11. The assembly of claim 1 wherein the first sensor includes a current transducer coupled to at least one of the first lamp terminal and the second lamp terminal.

12. The assembly of claim 11 wherein the current transducer transmits an AC sensed arc current value and the processor receives the AC arc sensed current value, further comprising an AC to DC converter coupled to receive the AC sensed arc current value and configured to generate an DC sensed arc current value, the processor being coupled to the AC to DC converter for receiving the generated DC sensed arc current value in addition to the AC sensed arc current value.

13. The assembly of claim 1 wherein the memory stores a ballast temperature threshold value, further comprising:
a temperature sensor for detecting an operating temperature of the ballast, the processor being coupled to the temperature sensor for receiving a detected ballast operating temperature, and having computer executable instructions for comparing detected ballast operating temperature to the stored ballast temperature threshold value, and generating a ballast temperature status message indicative of the comparing of the detected ballast operating temperature.

14. The assembly of claim 1 wherein the memory stores a ballast frequency threshold value, further comprising:
a frequency sensor for detecting an operating frequency of the ballast, the processor being coupled to the frequency sensor for receiving a detected ballast operating frequency, and having computer executable instructions for comparing detected ballast operating frequency to the stored ballast frequency threshold value, and generating a ballast frequency status message indicative of the comparing of the detected ballast operating frequency.

15. The assembly of claim 1 wherein the memory stores a ballast voltage threshold value, further comprising:
a ballast voltage sensor for detecting an operating voltage of the ballast, the processor being coupled to the ballast voltage sensor for receiving a detected ballast operating voltage, and having computer executable instructions for comparing detected ballast operating voltage to the stored ballast voltage threshold value, and generating a ballast operating voltage status message indicative of the comparing of the detected ballast operating voltage.

16. The assembly of claim 1 wherein the memory stores a ballast current threshold value, further comprising:
a ballast current sensor for detecting an operating current of the ballast, the processor being coupled to the ballast current sensor for receiving a detected ballast operating current, and having computer executable instructions for comparing detected ballast operating current to the stored ballast current threshold value, and generating a ballast operating current status message indicative of the comparing of the detected ballast operating current.

17. The assembly of claim 1 wherein the processor includes executable instructions for determining a quantity of light output of a received lamp as a function of the sensed arc current value and sensed arc voltage value.

18. The assembly of claim 1 wherein the processor includes executable instructions for determining a percentage of lamp life remaining and generating a message including the determined percentage of lamp life remaining.

19. The assembly of claim 1, further comprising
a third sensor for detecting a lamp voltage across the lamp interface when the lamp is received therein, the third sensor transmitting a sensed arc voltage value corresponding to the detected lamp voltage,
wherein the memory stores a threshold arc voltage value, and
the processor is coupled to the third sensor and receives the transmitted sensed arc voltage value, the processor further having computer executable instructions stored in the memory including instructions for performing the method of:
comparing the sensed arc voltage value with the stored threshold arc voltage value; and
generating an arc voltage status message responsive to the comparing of the sensed arc voltage value.

20. The assembly of claim 19 wherein the third sensor is a voltage divider circuit coupled between the first lamp terminal and the second lamp terminal of the lamp interface and the voltage divider circuit transmits an AC sensed arc voltage value and the processor receives the AC sensed arc voltage value, further comprising an AC to DC converter coupled to receive the AC sensed arc voltage value and configured to generate an DC sensed arc voltage value, the processor being coupled to the AC to DC converter for receiving the generated DC sensed arc voltage value in addition to the AC sensed arc voltage value.

21. The assembly of claim 1, further comprising:
a clock for determining a current time,
wherein the processor is coupled to clock for receiving the determined current time from the clock, and includes computer executable instructions stored in the memory for performing the method of:
detecting the receiving of a new lamp into the lamp interface;
determining from the clock a new lamp time corresponding to the detecting of the new lamp;
receiving and storing in the memory a new lamp sensed arc current value;
determining an age of the lamp as a function of a difference between a current time and the stored new lamp time;
comparing the current sensed arc current value and the current sensed arc voltage value with the stored new lamp sensed arc current value;
determining an end of life of the lamp as a function of the comparing to the stored new lamp arc current value; and
generating an end of lamp life message indicative of the determined end of life of the lamp.

22. An assembly for adaptively monitoring an operation of a gas discharge lamp fixture, the assembly comprising:
a power input interface for receiving input power from an external power source;
a ballast coupled to the power input interface receiving the received input power and creating lamp power between a first lamp terminal and a second lamp terminal, the created lamp power including a terminal voltage and a variable lamp current;
a lamp interface defined between the first lamp terminal and the second lamp terminal for receiving a gas discharge lamp for providing light responsive to receiving lamp power from the first and second lamp terminals;
a sensor for detecting an arc current circulating through a lamp received in the lamp interface, the sensor transmitting a sensed arc current value corresponding to the detected arc current;
a clock for determining a current time;
a memory for storing a threshold arc current value, and computer executable instructions; and
a processor coupled to the memory, the clock, and the first sensor, the processor receiving the determined current time from the clock, and the transmitted sensed arc current value from the first sensor, the processor receiving from the memory and executing the computer executable instructions for performing the method of:
detecting the receiving of a new lamp into the lamp interface;
determining from the clock a new lamp time corresponding to the detecting of the new lamp;
receiving and storing in the memory a new lamp sensed arc current value;
determining an age of the lamp as a function of a difference between a current time and the stored new lamp time;
comparing the current sensed arc current value and the current sensed arc voltage value with the stored new lamp sensed arc current value;
determining an end of life of the lamp as a function of the comparing to the stored new lamp arc current value; and
generating an end of lamp life message indicative of the determined end of life of the lamp.

23. The assembly of claim 22 wherein the processor also includes instructions for determining a percentage of lamp life remaining and generating a message including the determined percentage of lamp life remaining

24. An assembly for adaptively monitoring an operation of a gas discharge lamp fixture, the assembly comprising:
a power input interface for receiving input power from an external power source;
a ballast coupled to the power input interface receiving the received input power and creating lamp power between a first lamp terminal and a second lamp terminal, the created lamp power including a terminal voltage and a variable lamp current, the ballast including a transformer having a primary winding for receiving at least a portion of the input power, a first lamp powering secondary winding coupled to the first lamp terminal, a second lamp powering secondary winding coupled to the second lamp terminal, and a non-lamp powering secondary winding for detecting a ballast operating parameter and transmitting a sensed ballast operating parameter value corresponding to the detected ballast operating parameter;
a lamp interface defined between the first lamp terminal and the second lamp terminal for receiving a lamp for providing light responsive to receiving lamp power from the first and second lamp terminals;
a sensor for detecting an arc current circulating through a lamp received in the lamp interface, the sensor transmitting a sensed arc current value corresponding to the detected arc current;
a first output interface coupled to the sensor for providing the transmitted sensed arc current value to an external system communicatively coupled to the first output interface; and
a second output interface coupled to the third secondary winding for providing the transmitted sensed ballast operating parameter value to an external system communicatively coupled to the second output interface.

25. The assembly of claim 24 wherein the detected ballast operating parameter is selected from the group consisting of a voltage and a frequency.

26. A ballast for use with a gas discharge lamp fixture, the ballast comprising:
a power input interface for receiving input power from an external power source;
a transformer having a primary winding for receiving at least a portion of the input power;
a first secondary winding coupled to a first lamp terminal;
a second secondary winding coupled to a second lamp terminal, wherein lamp power is created between the first lamp terminal and the second lamp terminal, the created lamp power including a terminal voltage and a variable lamp current a lamp interface defined between the first lamp terminal and the second lamp terminal for receiving a lamp for providing light responsive to receiving the lamp power from the first and second lamp terminals;
a third secondary winding for detecting an induced voltage therein and transmitting a sensed ballast operating voltage value corresponding to the detected induced ballast voltage, the third secondary winding being magnetically coupled to the primary winding, and the first and second secondary windings, but electrically isolated from each and from the lamp interface; and
an output interface coupled to the third secondary winding for providing the transmitted sensed ballast operating voltage to an external system communicatively coupled to the output interface.

27. The ballast of claim 26, wherein the output interface is a first output interface, further comprising:
a sensor for detecting an arc current circulating through a lamp received in the lamp interface, the sensor transmitting a sensed arc current value corresponding to the detected arc current; and
a second output interface coupled to the sensor for providing the transmitted sensed arc current value to an external system communicatively coupled to the second output interface.
